(19) United States
(12) Patent Application Publication
(10) Pub. No.: US 2013/0155193 A1
(43) Pub. Date: Jun. 20, 2013

(54) IMAGE QUALITY EVALUATION APPARATUS AND METHOD OF CONTROLLING THE SAME

(71) Applicant: CANON KABUSHIKI KAISHA, Tokyo (JP)

(72) Inventor: Satoshi Ikeda, Tokyo (JP)

(73) Assignee: CANON KABUSHIKI KAISHA, Tokyo (JP)

(21) Appl. No.: 13/708,506

(22) Filed: Dec. 7, 2012

(30) Foreign Application Priority Data
Dec. 15, 2011 (JP) 2011-275089
Dec. 4, 2012 (JP) 2012-265668

(51) Int. Cl. H04N 13/02

(52) U.S. Cl. CPC H04N 13/02
USPC 348/46

(57) ABSTRACT

Autocorrelation coefficients for three dimensions defined by the horizontal direction, the vertical direction, and the time direction of evaluation target moving image data are acquired. A plurality of noise amounts are calculated by executing frequency analysis of the acquired autocorrelation coefficients for the three dimensions and multiplying each frequency analysis result by a visual response function representing the visual characteristic of a spatial frequency or a time frequency. The product of the plurality of calculated noise amounts is calculated as the moving image noise evaluation value of the evaluation target moving image data.

### BACKGROUND OF THE INVENTION

1. Field of the Invention

The present invention relates to an image quality evaluation apparatus for evaluating the noise characteristic of a moving image and a method of controlling the same.

2. Description of the Related Art

Conventionally, various methods have been developed to evaluate noise in a still image generated by an image capture apparatus such as a digital camera or an image input apparatus such as an image scanner.

For example, Japanese Patent Laid-Open No. 2004-064689 has developed a method for evaluating noise in a still image. In Japanese Patent Laid-Open No. 2004-064689, frequency conversion is performed for brightness information and perceptual chromaticity information to calculate a power spectrum. After removing halftone dot frequency components, the power spectrum is multiplied by visual characteristics, thereby calculating a noise evaluation value.

On the other hand, a method of evaluating noise in an image generated by a moving image capture apparatus such as a digital video camera has been developed as an extension of a still image noise evaluation method. For example, in Japanese Patent Laid-Open No. 2003-189337, the power amount of an AC component is calculated for each frame, and the average value of the power amounts is weighted by space visual characteristics, thereby calculating a noise evaluation value.

There also exists a method for evaluating noise that considers not only the space visual characteristic but also time visual characteristic. In Japanese Patent Laid-Open No. 2000-036971, filters having a space visual frequency characteristic and a time visual frequency characteristic are applied to three-dimensional data of a moving image. After that, a noise evaluation value is calculated by integrating noise amounts.

In Japanese Patent Laid-Open Nos. 2004-064689 and 2003-189337, the time frequency characteristic of noise is not taken into consideration, and the correlation to a subjective evaluation value is low.

Japanese Patent Laid-Open Nos. 2004-064689 and 2003-189337 consider only a spatial noise amount even for noise in a moving image, like a still image, and a temporal change is not taken into consideration. For example, a noise moving image of 24 fps is compared with that viewed as a still image. When viewing the moving image, the flickering of noise is more conspicuous, and the image strongly feels noisy. That is, when an image containing noise is displayed at a different frame rate, the perceived noise amount also changes. In the methods of Japanese Patent Laid-Open Nos. 2004-064689 and 2003-189337, however, the noise evaluation value does not change.

On the other hand, in the method according to Japanese Patent Laid-Open No. 2000-036971, the correlation to subjectivity is high because the space-time frequency characteristics of noise can be taken into consideration. However, the calculation amount is enormous. This is because the method in Japanese Patent Laid-Open No. 2000-036971 requires a spatial frequency filter to be applied to a three-dimensional image data and then a time frequency filter to be applied, too. When performing the same processing based on frequency analysis as well, the method requires a three-dimensional Fourier transformation processing to be executed and then multiply the data by space-time visual frequency characteristics, requiring an enormous amount of calculation.

### SUMMARY OF THE INVENTION

The present invention provides an image quality evaluation apparatus capable of efficiently calculating an evaluation value having high correlation to subjectivity and a method of controlling the same.

In order to achieve the above-described object, an image quality evaluation apparatus according to the present invention has the following arrangement. That is, the image quality evaluation apparatus for evaluating a noise characteristic of a moving image, comprises: an acquisition unit configured to acquire autocorrelation coefficients for three dimensions defined by a horizontal direction, a vertical direction, and a time direction of evaluation target moving image data; a calculation unit configured to calculate a plurality of noise amounts by executing frequency analysis of the autocorrelation coefficients for the three dimensions acquired by the acquisition unit and multiplying each frequency analysis result by a visual response function representing a visual characteristic of one of a spatial frequency and a time frequency; and an evaluation value calculation unit configured to calculate a product of the plurality of noise amounts calculated by the calculation unit as a moving image noise evaluation value of the evaluation target moving image data.

In the present invention, placing focus on the autocorrelation coefficient of noise as a noise characteristic, the autocorrelation coefficient is multiplied by a visual characteristic independently in the spatial and time directions, thereby calculating an evaluation value. More specifically, first, power spectra are calculated from autocorrelation coefficients for three dimensions of the time and spatial directions and multiplied by a visual frequency characteristic to calculate integrated values. The product of the integrated values is calculated, thereby calculating the moving image noise evaluation value.

According to the present invention, since not only the visual characteristic in the spatial direction but also the visual characteristic in the time direction can be taken into consideration, a noise evaluation value considering the temporal change in noise as well can be calculated. It is therefore possible to reflect the influence of the reproduction frame rate at the time of reproduction, or the like, and calculate an evaluation value having high correlation to subjectivity.

In addition, since the evaluation value is calculated by independently handling the noise characteristics in the spatial and time directions, the number of dimensions of Fourier transformation can be decreased, and the calculation amount can largely be decreased as compared to the method of Japanese Patent Laid-Open No. 2000-036971. Furthermore, the autocorrelation coefficient of noise is calculated in advance for each dimension that can be regarded as independent. For this reason, even when the noise characteristic has changed due to image processing or the like, the calculation amount when recalculating the evaluation value is small. For example, if only the NR coefficient in the time direction has changed, calculating only the autocorrelation coefficient in the time direction suffices.

Further features of the present invention will become apparent from the following description of exemplary embodiments (with reference to the attached drawings).

### BRIEF DESCRIPTION OF THE DRAWINGS

FIG. 1 is a schematic view showing an example of a chart image according to the first embodiment;

FIG. 2 is a block diagram showing the arrangement of an image quality evaluation apparatus according to the first embodiment;

FIG. 3 is a schematic view showing an application window according to the first embodiment;

FIG. 4 is a schematic view showing a dialogue window used to set image conditions according to the first embodiment;

FIG. 5 is a flowchart showing the operation of image quality evaluation processing according to the first embodiment;

FIG. 6A is a schematic view showing the relationship between an autocorrelation coefficient and an image signal according to the first embodiment;

FIG. 6B is a schematic view showing the relationship between an autocorrelation coefficient and an image signal according to the first embodiment;

FIG. 6C is a schematic view showing the relationship between an autocorrelation coefficient and an image signal according to the first embodiment;

FIG. 7 is a flowchart showing the operation of noise amount calculation processing according to the first embodiment;

FIG. 8A is a schematic view of a visual characteristic according to the first embodiment;

FIG. 8B is a schematic view of a visual characteristic according to the first embodiment;

FIG. 9 is a flowchart showing the operation of vertical-direction noise amount calculation processing according to the first embodiment;

FIG. 10 is a flowchart showing the operation of time-direction noise amount calculation processing according to the first embodiment;

FIG. 11 is a flowchart showing the operation of image quality evaluation processing according to the second embodiment;

FIG. 12A is a schematic view showing the relationship between an autocorrelation coefficient and an image signal according to the second embodiment;

FIG. 12B is a schematic view showing the relationship between an autocorrelation coefficient and an image signal according to the second embodiment;

FIG. 12C is a schematic view showing the relationship between an autocorrelation coefficient and an image signal according to the second embodiment;

FIG. 13 is a flowchart showing the operation of spatial-direction two-dimensional noise amount calculation processing according to the second embodiment;

FIG. 14 is a schematic view showing an application window according to the third embodiment;

FIG. 15 is a schematic view showing an information setting dialogue of noise evaluation value calculation according to the third embodiment;

FIG. 16 is a flowchart showing the operation of evaluation value calculation processing according to the third embodiment; and

FIG. 17 is a view showing an arrangement considering the time response characteristic of a display according to the third embodiment.

FIG. 18 is a view showing the arrangement of a noise matching apparatus according to the fifth embodiment;

FIG. 19 is a schematic view showing an application window according to the fifth embodiment;

FIG. 20 is a schematic view of a reproduced video used to acquire the step response of a display according to the fifth embodiment;

FIG. 21 is a flowchart showing the operation of noise amount correction processing according to the fifth embodiment;

FIG. 22 is a flowchart showing the operation of display time response characteristic acquisition processing according to the fifth embodiment;

FIG. 23 is a schematic view showing the step response of the display according to the fifth embodiment;

FIG. 24 is a schematic view showing the impulse response of the display according to the fifth embodiment;

FIG. 25 is a flowchart showing the operation of optimum parameter selection processing according to the fifth embodiment;

FIG. 26 is a schematic view of a reproduced video used to acquire the impulse response of the display according to the fifth embodiment;

FIG. 27 is a view showing the arrangement of a noise matching apparatus according to the sixth embodiment;

FIG. 28 is a schematic view showing an application window according to the sixth embodiment;

FIG. 29 is a schematic view showing a dialogue window used to set evaluation conditions according to the sixth embodiment;

FIG. 30 is a flowchart showing the operation of noise amount correction processing according to the sixth embodiment;

FIG. 31 is a flowchart showing the operation of noise amount correction processing according to the seventh embodiment; and

FIG. 32 is a flowchart showing the operation of image capture apparatus time response characteristic acquisition processing according to the seventh embodiment.

### DESCRIPTION OF THE EMBODIMENTS

The embodiments of the present invention will now be described in detail with reference to the accompanying drawings.

### First Embodiment

In the first embodiment, assuming that the characteristics of moving image noise in a moving image are independent in the horizontal direction, the vertical direction, and the time direction, a moving image noise quantitative evaluation value having high correlation to subjectivity is calculated in a small calculation amount. More specifically, an autocorrelation function (autocorrelation coefficient) is calculated in advance for each of the three dimensions, that is, the horizontal, vertical, and time directions and multiplied by a visual characteristic, thereby calculating a noise amount for each of the three dimensions. In addition, the calculated noise amounts for the respective dimensions are integrated by multiplication, thereby outputting a moving image noise evaluation value (noise perception amount).

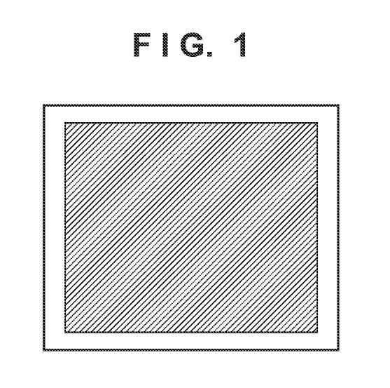

In the first embodiment, an image capture apparatus captures a chart image shown in FIG. 1, and an image quality evaluation apparatus evaluates the moving image noise perception amount. The arrangement of the image quality evaluation apparatus will be described first below. Detailed moving image noise evaluation processing (or a moving image noise evaluation program) will be explained as one of image quality evaluation processes.

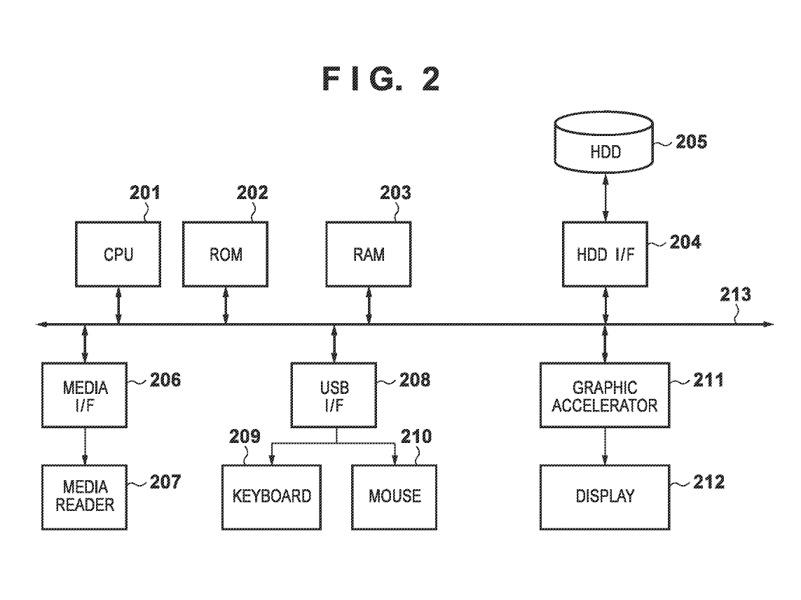

FIG. 2 is a block diagram showing the arrangement of the image quality evaluation apparatus that evaluates the moving image noise perception amount of the chart image captured by the image capture apparatus.

A CPU 201 executes the OS (Operating System) and various kinds of programs stored in a ROM 202 or a hard disk drive (HDD) 205 using a RAM 203 as a work memory. The CPU 201 controls various kinds of constituent elements via a system bus 213 such as a PCI (Peripheral Component Interconnect) bus. The CPU 201 executes a moving image noise evaluation program to be described later and various kinds of programs including a media reader driver. The CPU 201 accesses the HDD 205 via the system bus 213 and an HDD interface (I/F) 204.

The HDD interface (I/F) 204 connects a secondary storage device such as the HDD 205 or an optical disk drive. An example is an interface such as a serial ATA (SATA). The CPU 201 can read data from the HDD 205 or write data in the HDD 205 via the HDD interface (I/F) 204. The CPU 201 displays a user interface of processing to be described later or a processing result on a display 212 via a graphic accelerator 211. The CPU 201 receives a user instruction via a keyboard 209 and a mouse 210 which are connected to a USB interface (I/F) 208. The CPU 201 receives image data from a media reader 207 via a media interface (I/F) 206.

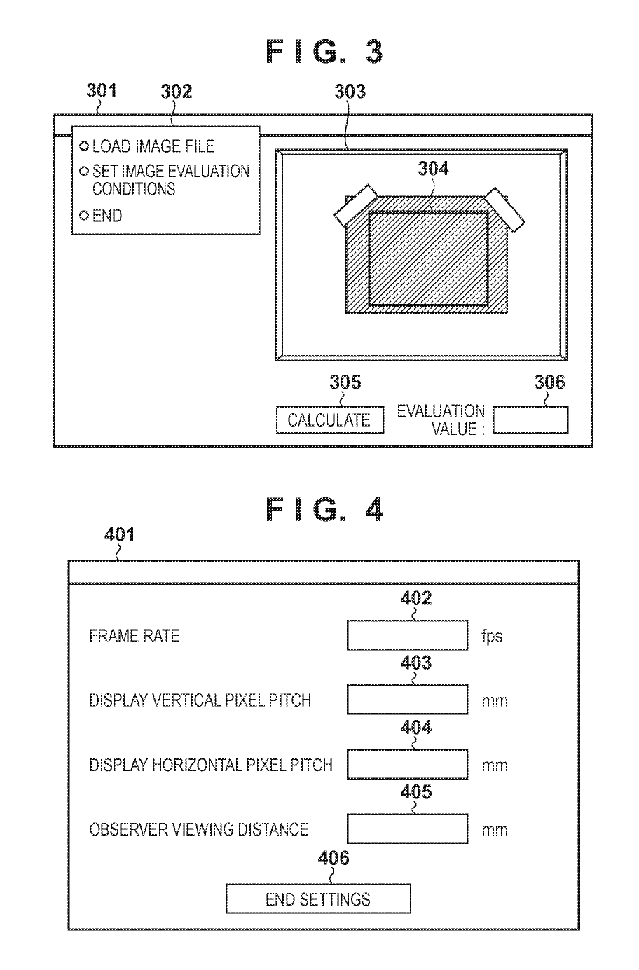

In the above-described arrangement, the moving image noise evaluation program operates in the following way. First, the moving image noise evaluation program stored in the HDD 205 is executed by the CPU 201 based on a user instruction input via the keyboard 209 and the mouse 210. An application window 301 shown in FIG. 3 is thus displayed on the display 212. The user selects “load image file” from a menu list 302 in the application window 301 and sets an image file to be processed. In accordance with program processing, an image file stored in a medium is transferred to the RAM 203 via the media reader 207 and the media interface (I/F) 206 as image data. An image file stored in the HDD 205 is transferred to the RAM 203 via the HDD interface (I/F) 204 as image data. The loaded image data is displayed in an image display area 303 on the display 212 via the graphic accelerator 211.

When the user selects “set image evaluation conditions” from the menu list 302, a dialogue window 401 shown in FIG. 4 is displayed on the display 212 to set image evaluation conditions. In the dialogue window 401, a frame rate setting editor 402 sets the display frame rate of the loaded image data. A display vertical pixel pitch setting editor 403 sets the vertical pixel pitch of the display to display the loaded image data. A display horizontal pixel pitch setting editor 404 sets the horizontal pixel pitch of the display to display the loaded image data. Finally, an observer viewing distance setting editor 405 sets a viewing distance for the user to observe the display. When the user presses a setting end button 406, the values input to the setting editors 402, 403, and 404 are stored in, for example, the RAM 203, and display of the dialogue window 401 is disabled.

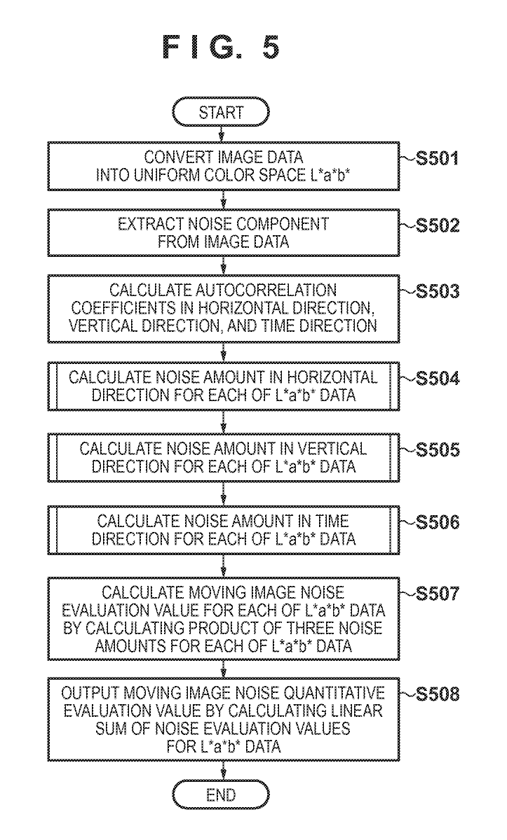

Next, the user designates an evaluation area 304 on the image display area 303 via the mouse 210. The evaluation area 304 needs to be set not to be larger than the chart image area of the captured image. When the user presses an evaluation value calculation button 305, image quality evaluation processing according to the flowchart of FIG. 5 to be described later is performed, and the calculated moving image noise evaluation value is displayed in an evaluation value display editor 306.

The image quality evaluation processing executed by the moving image noise evaluation program will be described below. In the first embodiment, an autocorrelation function is calculated in advance for each of the three dimensions, that is, the horizontal, vertical, and time directions of image data. In addition, a noise amount is calculated for each of the three dimensions using the respective autocorrelation functions and the space and time visual characteristics. The calculated noise amounts for the respective dimensions are integrated by multiplication, thereby outputting a moving image noise evaluation value. The contents of the processing will be described below in detail with reference to the flowchart of FIG. 5.

In step S501, color space conversion processing to be described later is performed for evaluation target image data (moving image data) loaded to the RAM 203 by the menu list 302, thereby converting the image data into a uniform color space.

In step S502, only a moving image noise component is extracted from the image data. More specifically, based on assumption that a stationary object such as a chart image is captured in the first embodiment, the image data is averaged in the time direction to calculate a temporal DC component. The calculated DC component is subtracted from the image data, thereby extracting only the moving image noise component.

In step S503, autocorrelation coefficients in the horizontal direction, vertical direction, and time direction of the extracted moving image noise component are calculated. Note that if the autocorrelation coefficients are held in a memory such as the RAM 203 in advance, the autocorrelation coefficients in the horizontal direction, vertical direction, and time direction are acquired from the RAM.

In step S504, the noise amount (first noise amount) in the horizontal direction is calculated from the autocorrelation coefficient of the noise in the horizontal direction and the horizontal-direction frequency sensitivity characteristic. The noise amount in the horizontal direction includes Hval_L calculated using the L* component, Hval_a calculated using the a* component, and Hval_b calculated using the b* component.

In step S505, the noise amount (second noise amount) in the vertical direction is calculated from the autocorrelation coefficient of the noise in the vertical direction and the vertical-direction frequency sensitivity characteristic. The noise amount in the vertical direction includes Vval_L calculated using the L* component, Vval_a calculated using the a* component, and Vval_b calculated using the b* component.

In step S506, the noise amount (third noise amount) in the time direction is calculated from the autocorrelation coefficient of the noise in the time direction and the time-direction frequency sensitivity characteristic. The noise amount in the time direction includes Tval_L calculated using the L* component, Tval_a calculated using the a* component, and Tval_b calculated using the b* component.

In step S507, a moving image noise evaluation value for each of the L*, a*, and b* components is calculated from the product of the noise amounts calculated in steps S504, S505, and S506. More specifically, a moving image noise evaluation value Nval_L of the L* component, a moving image noise evaluation value Nval_a of the a* component, and a moving image noise evaluation value Nval_b of the b* component are given by the following formula (1):

Nval_{—}L=Hval_{—}L*Vval_{—}L*Tval_{—}L

Nval_{—}a=Hval_{—}a*Vval_{—}a*Tval_{—}a

Nval_{—}b=Hval_{—}b*Vval_{—}b*Tval_{—}b (formula 1)

In step S508, a moving image noise quantitative evaluation value is calculated. More specifically, the noise evaluation value calculation processing is performed in the following way. The linear sum of the moving image noise evaluation values for the L*, a*, and b* components calculated in step S507 is obtained, thereby calculating the moving image noise quantitative evaluation value. More specifically, the moving image noise quantitative evaluation value is given by the following formula (2):

Nval_{—}L+a_weight*Nval_{—}a+b_weight*Nval_{—}b (formula 2)

where a_weight and b_weight are weight coefficients.

The color space conversion processing in step S501 will be described below in detail. First, the image data loaded to the RAM 203 by the menu list 302 is decoded into three-dimensional RGB data. The RGB pixel values of a pixel that is the xth in the horizontal direction and the yth in the vertical direction from the upper left corner of the tth frame image are expressed as R(x, y, t), G(x, y, t), and B(x, y, t), respectively. Tristimulus values X, Y, and Z are calculated from the RGB data. The values are converted into L*, a*, and b* values. In the first embodiment, the conversion from RGB to XYZ is executed using transformations from RGB to XYZ defined in ITU-T BT.709. More specifically, the 8-bit data R(x, y, t), G(x, y, t), and B(x, y, t) are normalized to a value ranging from 0 to 1 (both inclusive) and multiplied by the γ characteristic of the display, thereby calculating R′(x, y, t), G′(x, y, t), and B′(x, y, t) by the following formula (3):

R′(x,y,t)=[R(x,y,t)/255)]^{γ}

G′(x,y,t)=[G(x,y,t)/255)]^{γ}

B′(x,y,t)=[B(x,y,t)/255)]^{γ} (formula 3)

The values are converted into the tristimulus values X, Y, and Z by the following formula (4):

$$[ \begin{matrix}X ( x , y , t ) \\ Y ( x , y , t ) \\ Z ( x , y , t )\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] [ \begin{matrix}{R}^{′} ( x , y , t ) \\ {B}^{′} ( x , y , t ) \\ {G}^{′} ( x , y , t )\end{matrix} ] \qquad ( formula 4 )$$

The tristimulus values X, Y, and Z are converted into the L*, a*, and b* values by the following formula (5):

$$L * ( x , y , t ) = {( \frac{Y ( x , y , t )}{{Y}_{n}} )}^{1 / 3} - 16 \\ a * ( x , y , t ) = 500 [ {( \frac{X ( x , y , t )}{{X}_{n}} )}^{1 / 3} - {( \frac{Y ( x , y , t )}{{Y}_{n}} )}^{1 / 3} ] \\ b * ( x , y , t ) = 500 [ {( \frac{Y ( x , y , t )}{{Y}_{n}} )}^{1 / 3} - {( \frac{Z ( x , y , t )}{{Z}_{n}} )}^{1 / 3} ] \qquad ( formula 5 )$$

The noise component extraction processing in step S502 will be described below. The first embodiment assumes that a stationary object such as a chart image is captured, and moving image noise is evaluated. A temporally fixed pattern is regarded as a component other than noise and subtracted, thereby extracting only the moving image noise component. More specifically, a brightness noise component NL, an a* color difference noise component Na, and a b* color difference noise component Nb are extracted by the following formula (6):

$$NL ( x , y , t ) = L ( x , y , t ) - \frac{1}{T} {\sum }_{t = 1}^{T} L ( x , y , t ) \\ Na ( x , y , t ) = a ( x , y , t ) - \frac{1}{T} {\sum }_{t = 1}^{T} a ( x , y , t ) \\ Nb ( x , y , t ) = b ( x , y , t ) - \frac{1}{T} {\sum }_{t = 1}^{T} b ( x , y , t ) \qquad ( formula 6 )$$

where T is the number of frames of the image.

The autocorrelation coefficient acquisition processing in step S503 will be described below in detail.

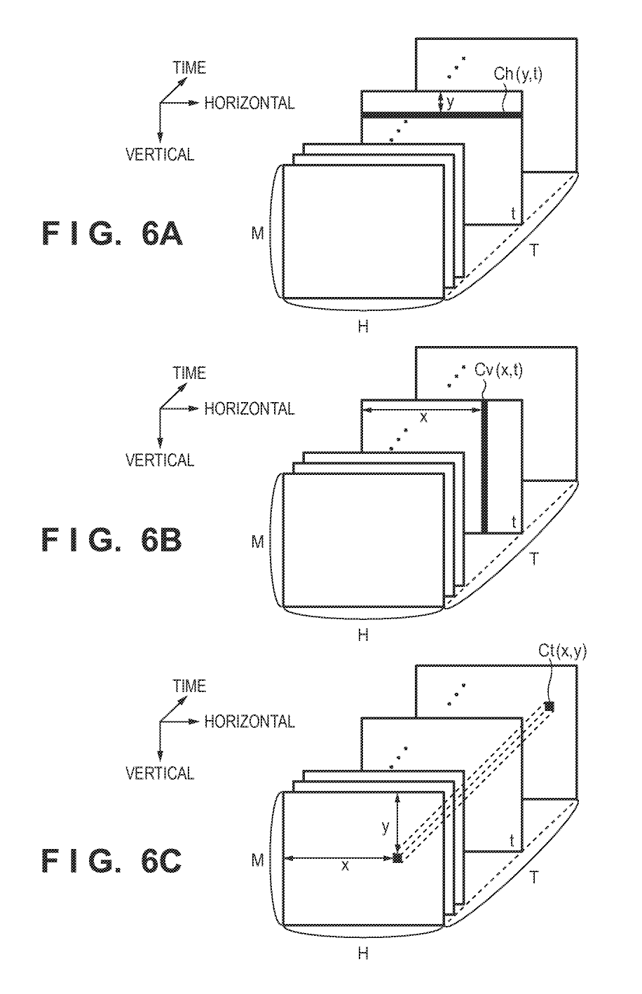

The method of calculating the autocorrelation coefficient in the horizontal direction will be described first. An autocorrelation coefficient of the yₕth row in the tₕth frame is calculated as shown in FIG. 6A as the representative value of the autocorrelation coefficient in the horizontal direction of the noise component. Autocorrelation coefficients Ch_L, Ch_a, and Ch_b in the horizontal direction for the L*, a*, and b* components are calculated as the following formula (7):

$$Ch\_L ( x , {y}_{h} , {t}_{h} ) = {\sum }_{i = 1}^{N} NL ( x , {y}_{h} , {t}_{h} ) * NL ( x + i , {y}_{h} , {t}_{h} ) \\ Ch\_a ( x , {y}_{h} , {t}_{h} ) = {\sum }_{i = 1}^{N} Na ( x , {y}_{h} , {t}_{h} ) * Na ( x + i , {y}_{h} , {t}_{h} ) \\ Ch\_b ( x , {y}_{h} , {t}_{h} ) = {\sum }_{i = 1}^{N} Nb ( x , {y}_{r} , {t}_{h} ) * Nb ( x + i , {y}_{h} , {t}_{h} ) \qquad ( formula 7 )$$

where N is the number of horizontal pixels of the image data.

The autocorrelation coefficient in the vertical direction will be described next. An autocorrelation coefficient of the xᵥth pixel in the tᵥth frame is calculated as shown in FIG. 6B as the representative value of the autocorrelation coefficient in the horizontal direction of the noise.

Autocorrelation coefficients Cv_L, Cv_a, and Cv_b in the vertical direction for the L*, a*, and b* components are calculated as the following formula (8):

$$Cv\_L ( {x}_{v} , y , {t}_{v} ) = {\sum }_{i = 1}^{M} NL ( {x}_{v} , y , {t}_{v} ) * NL ( {x}_{v} , y + i , {t}_{v} ) \\ Cv\_a ( {x}_{v} , y , {t}_{v} ) = {\sum }_{i = 1}^{M} Na ( {x}_{v} , y , {t}_{v} ) * Na ( {x}_{v} , y + i , {t}_{v} ) \\ Cv\_b ( {x}_{v} , y , {t}_{v} ) = {\sum }_{i = 1}^{M} Nb ( {x}_{v} , y , {t}_{v} ) * Nb ( {x}_{v} , y + i , {t}_{v} ) \qquad ( formula 8 )$$

where M is the number of vertical pixels of the image data.

Finally, the method of calculating the autocorrelation coefficient in the time direction will be described.

An autocorrelation coefficient of the pixel that is the x_{f}th in the horizontal direction and the y_{f}th in the vertical direction is calculated as shown in FIG. 6C as the representative value of the autocorrelation coefficient in the time direction of the noise. Autocorrelation coefficients Ct_L, Ct_a, and Ct_b in the time direction for the L*, a*, and b* components are calculated as the following formula (9):

$$Ct\_L ( {x}_{f} , {y}_{f} , t ) = {\sum }_{i = 1}^{T} NL ( {x}_{f} , {y}_{f} , t ) * NL ( {x}_{f} , {y}_{f} , t + i ) \\ Ct\_a ( {x}_{f} , {y}_{f} , t ) = {\sum }_{i = 1}^{T} Na ( {x}_{f} , {y}_{f} , t ) * Na ( {x}_{f} , {y}_{f} , t + i ) \\ Ct\_b ( {x}_{f} , {y}_{f} , t ) = {\sum }_{i = 1}^{T} Nb ( {x}_{f} , {y}_{f} , t ) * Nb ( {x}_{f} , {y}_{f} , t + i ) \qquad ( formula 9 )$$

where T is the number of frames of the image data.

Note that the autocorrelation coefficient for one column of the Lab data may directly be acquired as the autocorrelation coefficient of noise, as described above, or autocorrelation coefficients for a plurality of columns may be calculated and averaged. When calculating the average in the whole image data, for example, Ch_L is calculated by the following formula (10):

$$Ch\_L ( x , y , t ) = {\sum }_{i = 1}^{N} {\sum }_{y = 1}^{M} {\sum }_{t = 1}^{T} NL ( x , y , t ) * NL ( x + i , y , t ) \qquad ( formula 10 )$$

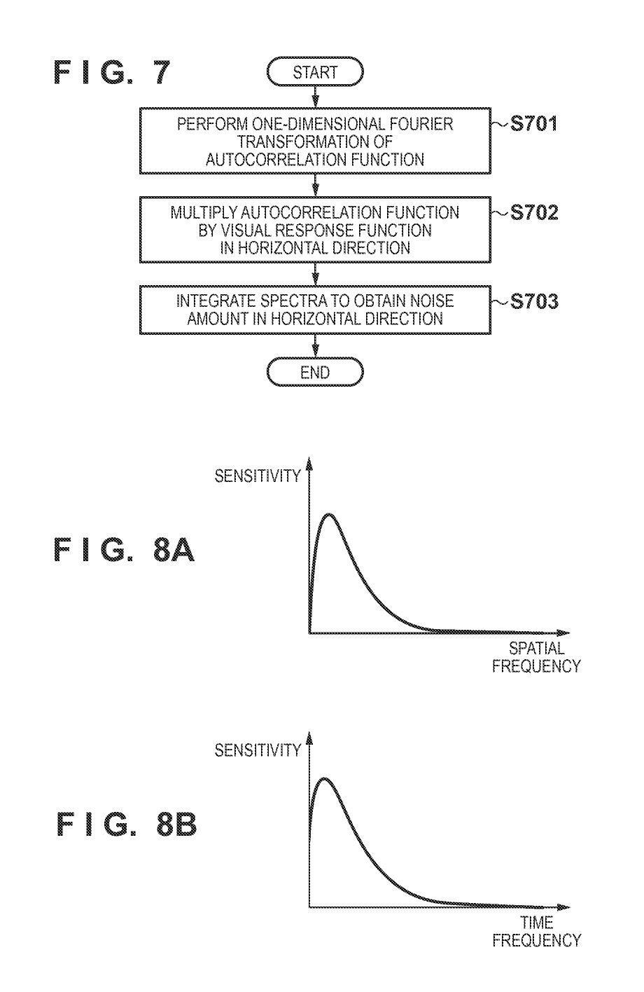

The method of calculating the noise amount Hval in the horizontal direction in step S504 will be described below in detail with reference to the flowchart of FIG. 7.

In step S701, one-dimensional Fourier transformation is applied as frequency analysis for the autocorrelation coefficient calculated in step S503. Let Fch_L(u) be the Fourier transformation result of Ch_L(x), Fch_a(u) be the Fourier transformation result of Ch_a(x), and Fch_b(u) be the Fourier transformation result of Ch_b(x). In this case, u is the spatial frequency (the unit is cycles/degree) in the horizontal direction.

In step S702, the results are multiplied by a visual characteristic VTF(u) in the horizontal direction shown in FIG. 8A. To multiply Fch(u) by the visual characteristic, the unit of the spatial frequency needs to match. Let px be the vertical pixel pitch designed by the display horizontal pixel pitch setting editor 404, R be the viewing distance designated by the observer viewing distance setting editor 405, and Nx be the size of the evaluation target image. In this case, based on a Dooley's space VTF, a visual response function VTFs(u) is given by the following formula (11):

$$VTFs ( u ) = 5.05 * ( 1 - exp ( - 0.1 * \frac{R \cdot π}{Nx \cdot px \cdot 180} u ) ) * exp ( - 0.138 * \frac{R \cdot π}{Nx \cdot px \cdot 180} * u ) \qquad ( formula 11 )$$

Hence, Fch_L(u), Fch_a(u), and Fch_b(u) are multiplied by the visual characteristic (visual response function) to obtain Fch_L′(u), Fch_a′(u), and Fch_b′(u) which are given by the following formula (12):

Fch_{—}L′(u)=Fch_{—}L(u)*VTFs(u)

Fch_{—}a′(u)=Fch_{—}a(u)*VTFs(u)

Fch_{—}b′(u)Fch_{—}b(u)*VTFs(u) (formula 12)

In step S703, the integrated value of the spectra of Fch_L′, Fch_a′, and Fch_b′ is calculated to obtain the noise amount in the horizontal direction. More specifically, Hval_L, Hval_a, and Hval_b are given by the following formula (13):

$$Hval\_L = {\sum }_{u} {Fch\_L}^{′} ( u ) \\ Hval\_a = {\sum }_{u} {Fch\_a}^{′} ( u ) \\ Hval\_b = {\sum }_{u} {Fch\_b}^{′} ( u ) \qquad ( formula 13 )$$

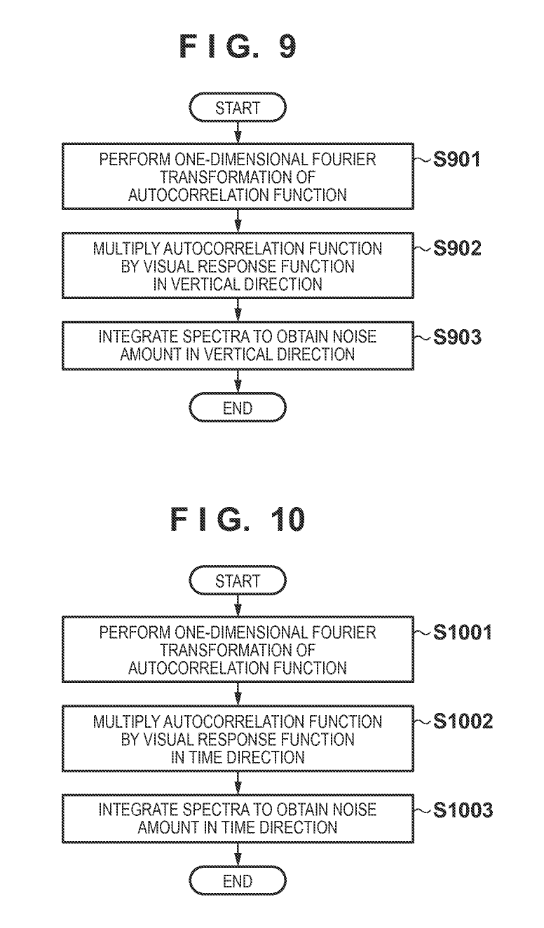

The method of calculating the noise amount Vval in the vertical direction in step S505 will be described below. The noise amount Vval in the vertical direction can be calculated like the noise amount Hval in the horizontal direction in step S504. This will be described below in detail with reference to the flowchart of FIG. 9.

In step S901, one-dimensional Fourier transformation is applied as frequency analysis for the calculated autocorrelation coefficient. Let Fcv_L(v) be the Fourier transformation result of Cv_L(x), Fcv_a(v) be the Fourier transformation result of Cv_a(x), and Fcv_b(v) be the Fourier transformation result of Cv_b(x). In this case, v is the spatial frequency (the unit is cycles/degree) in the vertical direction.

In step S902, the results are multiplied by the visual characteristic in the vertical direction shown in FIG. 8A. In this embodiment, the visual response function VTFs(v) is also used as the visual characteristic in the vertical direction, as in step S702. To multiply Fcv(v) by the visual characteristic, the unit of the spatial frequency needs to match. Let py be the vertical pixel pitch designed by the display vertical pixel pitch setting editor 403, R be the viewing distance designated by the observer viewing distance setting editor 405, and Ny be the vertical size of the evaluation target image. In this case, based on the Dooley's space VTF, the visual response function VTFs(v) is given by the following formula (14):

$$VTFs ( v ) = 5.05 * ( 1 - exp ( - 0.1 * \frac{R \cdot π}{Ny \cdot py \cdot 180} v ) ) * exp ( - 0.138 * \frac{R \cdot π}{Ny \cdot py \cdot 180} * v ) \qquad ( formula 14 )$$

Hence, Fcv_L(v), Fcv_a(v), and Fcv_b(v) are multiplied by the visual characteristic (visual response function) to obtain Fcv_L′(v), Fcv_a′(v), and Fcv_b′(v) which are given by the following formula (15):

Fcv_{—}L′(ν)=Fch_{—}L(ν)*VTFs(ν)

Fcv_{—}a′(ν)=Fch_{—}a(ν)*VTFs(ν)

Fcv_{—}b′(ν)==Fch_{—}b(ν)*VTFs(ν) (formula 15)

In step S903, the noise amounts Vval_L, Vval_a, and Vval_b in the vertical direction are calculated by the following formula (16):

$$Vval\_L = {\sum }_{v} {Fcv\_L}^{′} ( v ) \\ Vval\_a = {\sum }_{v} {Fcv\_a}^{′} ( v ) \\ Vval\_b = {\sum }_{v} {Fcv\_b}^{′} ( v ) \qquad ( formula 16 )$$

The method of calculating the noise amount Tval in the time direction in step S506 will be described below. The noise amount Tval in the time direction can be calculated like the noise amount Hval in the horizontal direction in step S504. This will be described below in detail with reference to the flowchart of FIG. 10.

In step S1001, one-dimensional Fourier transformation is applied as frequency analysis for the calculated autocorrelation coefficient. Let Fct_L(f) be the Fourier transformation result of Ct_L(t), Fct_a(f) be the Fourier transformation result of Ct_a(t), and Fct_b(f) be the Fourier transformation result of Ct_b(t). In this case, f is the time frequency (the unit is Hz) in the time direction.

In step S1002, the results are multiplied by the visual characteristic in the time direction shown in FIG. 8B. To multiply Fct(f) by the visual characteristic, the unit of the time frequency needs to match. Let s[sec] be the frame interval at the time of image capture. Based on the Kelly's time VTF, the shape of the visual response function VTFs(f) to multiply is given by the following formula (17):

$$VTFt ( f ) = 4.02 * ( 1 - 0.85 * exp ( - 0.1 * \frac{f}{2 s} ) * exp ( - 0.138 * \frac{f}{2 s} ) \qquad ( formula 17 )$$

In addition, letting s[sec] be the frame interval at the time of image capture, the frequency unit of VTFt is represented by ½s [Hz]. Hence, Fct_L(f), Fct_a(f), and Fct_b(f) are multiplied by the visual characteristic (visual response function) to obtain Fct_L′(f), Fct_a′(f), and Fct_b′(f) which are given by the following formula (18):

Fct_{—}L′(f)=Fct_{—}L(f)*VTFt(f)

Fct_{—}a′(f)=Fct_{—}a(uf*VTFt(f)

Fct_{—}b′(f)=Fct_{—}b(uf*VTFt(f) (formula 18)

In step S1003, the noise amounts Tval_L, Tval_a, and Tval_b in the time direction are calculated by the following formula (19):

$$Tval\_L = {\sum }_{f} {Fct\_L}^{′} ( f ) \\ Tval\_a = {\sum }_{f} {Fct\_a}^{′} ( f ) \\ Tval\_b = {\sum }_{f} {Fct\_b}^{′} ( f ) \qquad ( formula 19 )$$

As described above, in the first embodiment, the representative value of the autocorrelation function is calculated for each of the three dimensions, that is, the horizontal, vertical, and time directions and multiplied by the visual characteristic (visual response function), thereby calculating the noise amount for each of the three dimensions. This makes it possible to consider the spatial and time characteristics of noise in a small calculation amount and calculate a quantitative evaluation value having high correlation to subjectivity.

In the first embodiment, the moving image noise evaluation program executes the moving image noise evaluation processing in FIG. 5. However, the present invention is not limited to this. All or some of the steps of the moving image noise evaluation processing in FIG. 5 may be implemented by dedicated hardware or by cooperation of hardware and software (program).

### Second Embodiment

In the second embodiment, an evaluation value is calculated without regarding the noise characteristic as independent in the horizontal and vertical directions, unlike the first embodiment. This allows to cope with, for example, a case in which image data has undergone noise reduction in the two-dimensional spatial direction. In the second embodiment, the representative value of the autocorrelation coefficient is calculated for each of the two-dimensional spatial direction and the one-dimensional time direction. Points of difference from the first embodiment will be described below.

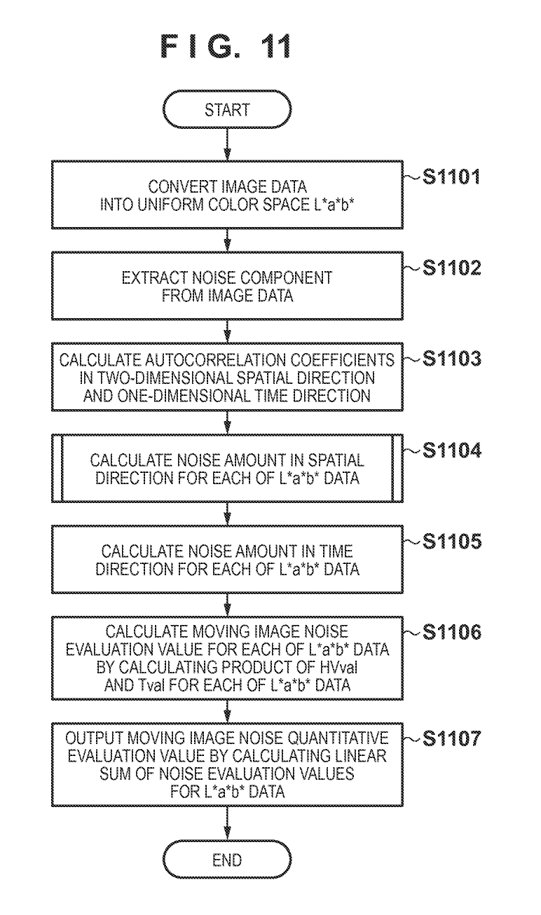

Image quality evaluation processing executed by a moving image noise evaluation program will be described with reference to the flowchart of FIG. 11.

In step S1101, color space conversion processing to be described later is performed for image data loaded to a RAM 203 by a menu list 302, thereby converting the image data into a uniform color space. This processing is the same as in the first embodiment.

In step S1102, a moving image noise component is extracted from the image data. This processing is the same as in the first embodiment.

In step S1103, an autocorrelation coefficient in the two-dimensional spatial direction and an autocorrelation coefficient in the one-dimensional time direction are calculated. Detailed processing in step S1103 will be described later.

In step S1104, the noise amount (first noise amount) in the spatial direction is calculated from the autocorrelation coefficient of the noise in the horizontal-vertical direction and the horizontal-vertical-direction frequency sensitivity characteristic. The noise amount in the spatial direction includes HVval_L calculated using the L* component, HVval_a calculated using the a* component, and HVval_b calculated using the b* component. Detailed processing in step S1104 will be described later.

In step S1105, the noise amount (second noise amount) in the time direction is calculated from the autocorrelation coefficient of the noise in the time direction and the horizontal-direction frequency sensitivity characteristic. The noise amount in the time direction includes Tval_L calculated using the L* component, Tval_a calculated using the a* component, and Tval_b calculated using the b* component. This processing is the same as in the first embodiment.

In step S1106, a moving image noise evaluation value is calculated from the product of the noise amounts calculated in steps S1104 and S1105. More specifically, a moving image noise evaluation value Nval_L of the L* component, a moving image noise evaluation value Nval_a of the a* component, and a moving image noise evaluation value Nval_b of the b* component are given by the following formula (20):

Nval_{—}L=HVval_{—}L*Tval_{—}L

Nval_{—}a=HVval_{—}a*Tval_{—}a

Nval_{—}b=HVval_{—}b*Tval_{—}b (formula 20)

In step S1107, a moving image noise quantitative evaluation value is calculated by calculating the linear sum of the values calculated in step S1106.

The autocorrelation coefficient calculation processing in step S1103 will be described below. Note that the method of calculating the autocorrelation coefficient in the one-dimensional time direction is the same as in the first embodiment, and only the method of calculating the autocorrelation coefficient in the two-dimensional spatial direction will be described below.

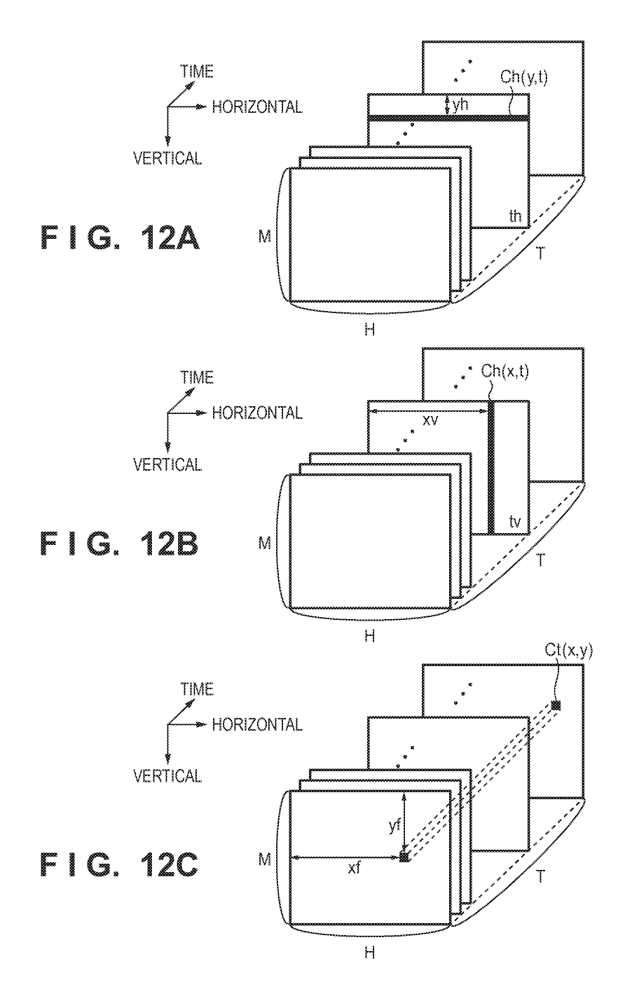

The autocorrelation coefficient in the two-dimensional spatial direction of noise is calculated in the following way. An autocorrelation coefficient for the tₕth frame image is calculated as shown in FIGS. 12A to 12C as the representative value of the autocorrelation coefficient in the two-dimensional spatial direction of the noise. Autocorrelation coefficients Chv_L, Chv_a, and Chv_b in the two-dimensional spatial direction for the L*, a*, and b* components are calculated as the following formula (21):

$$Chv\_L ( x , y ) = {\sum }_{i = 1}^{N} {\sum }_{j = 1}^{M} NL ( x , y , t ) * NL ( x + i , y + j , t ) \\ Chv\_a ( x , y ) = {\sum }_{i = 1}^{N} {\sum }_{j = 1}^{M} Na ( x , y , t ) * Na ( x + i , y + j , t ) \\ Chv\_b ( x , y ) = {\sum }_{i = 1}^{N} {\sum }_{j = 1}^{M} Nb ( x , y , t ) * Nb ( x + i , y + j , t ) \qquad ( formula 21 )$$

Note that the autocorrelation coefficient for one row of the Lab data may directly be acquired as the autocorrelation coefficient of noise, as described above, or autocorrelation coefficients for a plurality of rows may be calculated and averaged.

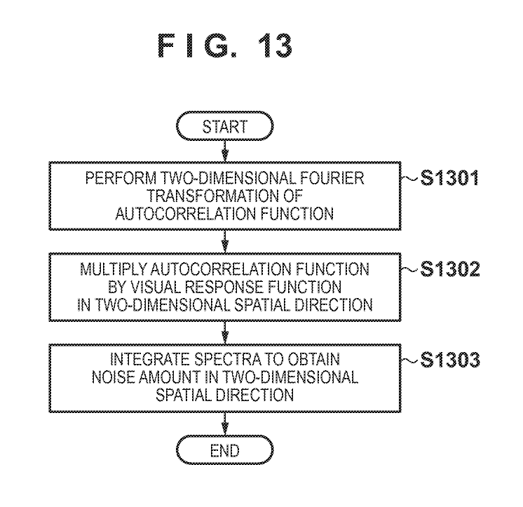

Calculation of the noise amount in the two-dimensional spatial direction in step S1104 will be described below in detail with reference to the flowchart of FIG. 13.

In step S1301, two-dimensional Fourier transformation is applied as frequency analysis for the calculated autocorrelation coefficient. Let Fchv_L(u, v) be the Fourier transformation result of Chv_L(x, y), Fchv_a(u, v) be the Fourier transformation result of Chv_a(x, y), and Fchv_b(u, v) be the Fourier transformation result of Chv_b(x, y). In this case, u is the spatial frequency (the unit is cycles/degree) in the horizontal direction, and v is the spatial frequency (the unit is cycles/degree) in the vertical direction.

In step S1302, the results are multiplied by a visual characteristic (visual response function) in the two-dimensional spatial direction. More specifically, a visual characteristic VTFs(u, v) to multiply in the second embodiment is given by the following formula (22):

$$VTFs ( u , v ) = 5.05 * ( 1 - exp ( - 0.1 * \sqrt{{( \frac{R \cdot π}{Nx \cdot px \cdot 180} u )}^{2} + {( \frac{R \cdot π}{Nx \cdot px \cdot 180} v )}^{2}} ) ) * exp ( - 0.138 * \sqrt{{( \frac{R \cdot π}{Nx \cdot px \cdot 180} u )}^{2} + {( \frac{R \cdot π}{Nx \cdot px \cdot 180} v )}^{2}} ) \qquad ( formula 22 )$$

where px and py are the vertical and horizontal pixel pitches of the display, Nx and Ny are the vertical and horizontal sizes of the evaluation image, and R is the viewing distance of the observer. Hence, Fchv_L(u, v), Fchv_a(u, v), and Fchv_b(u, v) are multiplied by the visual characteristic to obtain Fchv_L′(u, v), Fchv_a′(u, v), and Fchv_b′(u, v) which are given by the following formula (23):

Fch_{—}L′(u,v)=Fch_{—}L(u,v)*VTFs(u,v)

Fch_{—}a′(u,v)=Fch_{—}a(u,v)*VTFs(u,v)

Fch_{—}b′(u,v)=Fch_{—}b(u,v)*VTFs(u,v) (formula 23)

In step S1303, the integrated value of the spectra of Fchv_L′, Fchv_a′, and Fchv_b′ is calculated to obtain the noise amount in the two-dimensional spatial direction. More specifically, the noise amounts HVval_L, HVval_a, and HVval_b in the two-dimensional spatial direction are given by the following formula (24):

$$HVval\_L = {\sum }_{u} {\sum }_{v} {Fchv\_L}^{′} ( u , v ) \\ HVval\_a = {\sum }_{u} {\sum }_{v} {Fchv\_a}^{′} ( u , v ) \\ HVval\_b = {\sum }_{u} {\sum }_{v} {Fchv\_b}^{′} ( u , v ) \qquad ( formula 24 )$$

As described above, according to the second embodiment, the noise evaluation value is calculated in consideration of the noise amount in the two-dimensional spatial direction, in addition to the effects described in the first embodiment. It is therefore possible to cope with, for example, a case in which image data has undergone noise reduction in the two-dimensional spatial direction.

In the second embodiment, the moving image noise evaluation program executes the moving image noise evaluation processing in FIG. 11. However, the present invention is not limited to this. All or some of the steps of the moving image noise evaluation processing in FIG. 11 may be implemented by dedicated hardware or by cooperation of hardware and software (program).

### Third Embodiment

In the third embodiment, when the noise characteristic of a noise image having temporarily undergone evaluation value calculation has changed, the evaluation value is incrementally calculated while placing focus only on the difference of the noise characteristic. In the first embodiment, the noise characteristic of moving image noise is held as an autocorrelation coefficient in advance, and a moving image noise evaluation value is calculated based on the autocorrelation coefficient. For this reason, for example, when only the time characteristic of noise has changed, the noise evaluation value can be calculated without recalculating the frequency characteristics in the horizontal direction and vertical direction. In this case, the evaluation values in the horizontal direction and vertical direction can be reused. Calculating only evaluation values Tval_L, Tval_a, and Tval_b in the time direction suffices. Points of difference from the first embodiment will be described below.

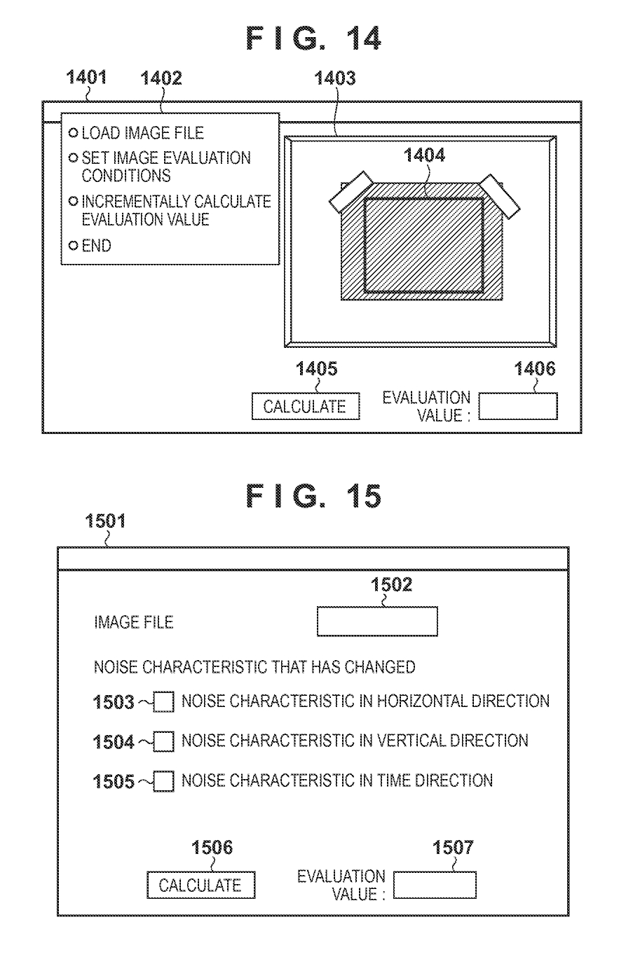

Evaluation value recalculation when the noise characteristic has changed is performed in the following way. First, the user activates a moving image noise evaluation program stored in an HDD 205 via a keyboard 209 and a mouse 210. An application window 1401 shown in FIG. 14 is thus displayed on a display 212. The user temporarily calculates the moving image noise quantitative evaluation value in accordance with the procedure described in the first embodiment.

The user clicks “incrementally calculate evaluation value” in a menu list 1402. An information setting dialogue 1501 shown in FIG. 15 is thus displayed on the display 212. The user inputs the file path of an image file for which a moving image noise evaluation value is to be calculated to an image file designation editor 1502. The user checks (designates), using the mouse 210, a check box corresponding to the noise characteristic that has changed from the already calculated image data out of check boxes 1503 to 1505 respectively corresponding to the noise characteristics in the horizontal direction, vertical direction, and time direction.

For example, to evaluate image data that has undergone only time noise reduction processing from image data for which an evaluation value has been calculated, the user checks only the check box 1505. When the user presses a calculation button 1506, incremental evaluation value calculation processing to be described later is executed, and the moving image noise evaluation value calculation result is displayed in an editor 1507.

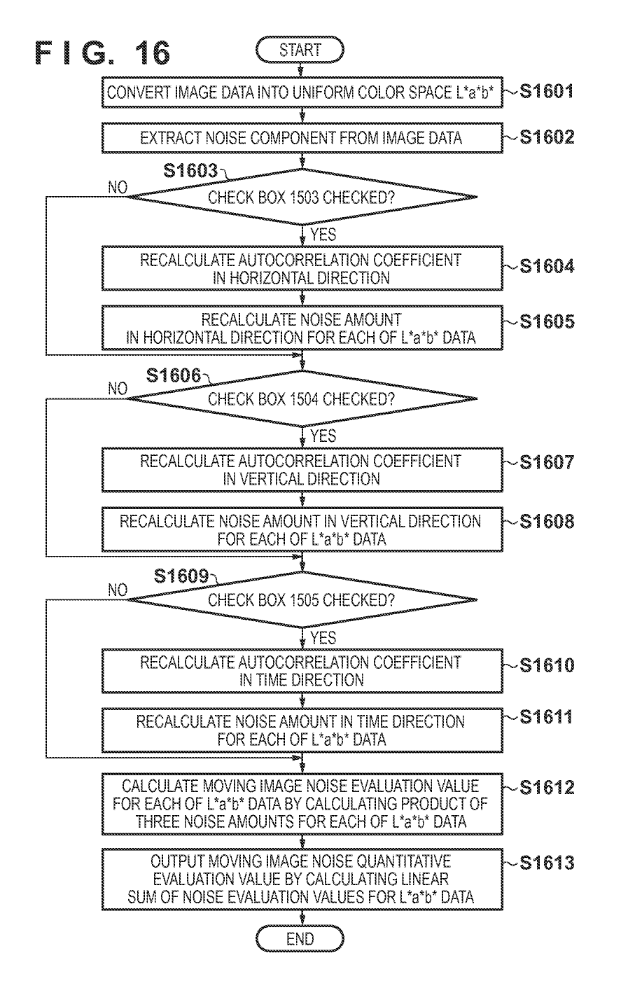

The contents of the incremental evaluation value calculation processing according to the third embodiment will be described below in detail with reference to the flowchart of FIG. 16.

In step S1601, an image file designated by the image file designation editor 1502 is loaded to a RAM 203. Color space conversion processing is performed to convert the image data into a uniform color space. The color conversion processing in this step is the same as in step S501 of FIG. 5 of the first embodiment.

In step S1602, only a moving image noise component is extracted from the image data. This step is the same as step S502 of FIG. 5 of the first embodiment.

In step S1603, it is determined whether the user has checked the check box 1503 of the noise characteristic in the horizontal direction. If the user has checked this check box (YES in step S1603), the process advances to step S1604. If the user has not checked the check box (NO in step S1603), the process advances to step S1606.

In step S1604, the autocorrelation coefficient in the horizontal direction is recalculated. The recalculation of the autocorrelation coefficient in the horizontal direction is the same as in step S503 of FIG. 5 of the first embodiment.

In step S1605, the noise amount in the horizontal direction is recalculated. The processing in this step is the same as in step S504 of FIG. 5 of the first embodiment.

In step S1606, it is determined whether the user has checked the check box 1504. If the user has checked this check box (YES in step S1606), the process advances to step S1607. If the user has not checked the check box (NO in step S1606), the process advances to step S1609.

In step S1607, the autocorrelation coefficient in the vertical direction is recalculated. The recalculation of the autocorrelation coefficient in the vertical direction is the same as in step S503 of FIG. 5 of the first embodiment.

In step S1608, the noise amount in the vertical direction is recalculated. The processing in this step is the same as in step S505 of FIG. 5 of the first embodiment.

In step S1609, it is determined whether the user has checked the check box 1505. If the user has checked this check box (YES in step S1609), the process advances to step S1610. If the user has not checked the check box (NO in step S1609), the process advances to step S1612.

In step S1610, the autocorrelation coefficient in the time direction is recalculated. The recalculation of the autocorrelation coefficient in the time direction is the same as in step S503 of FIG. 5 of the first embodiment.

In step S1611, the noise amount in the time direction is recalculated. The processing in this step is the same as in step S506 of FIG. 5 of the first embodiment.

In step S1612, a moving image noise evaluation value for each of the L*, a*, and b* components is calculated from the product of the calculated/recalculated noise amounts. More specifically, a moving image noise evaluation value Nval_L of the L* component, a moving image noise evaluation value Nval_a of the a* component, and a moving image noise evaluation value Nval_b of the b* component are given by the following formula (25):

Nval_{—}L=Hval_{—}L*Vval_{—}L*Tval_{—}L

Nval_{—}a=Hval_{—}a*Vval_{—}a*Tval_{—}a

Nval_{—}b=Hval_{—}b*Vval_{—}b*Tval_{—}b (formula 25)

In step S1613, a moving image noise quantitative evaluation value is calculated by calculating the linear sum of the moving image noise evaluation values calculated in step S1612. More specifically, the moving image noise quantitative evaluation value is given by the following formula (26):

Nval_{—}L+a_weight*Nval_{—}a+b_weight*Nval_{—}b (formula 26)

where a_weight and b_weight are weight coefficients.

As described above, according to the third embodiment, when at least one of the noise characteristics in the horizontal, vertical and time directions has changed, the evaluation value for the noise characteristic of the dimension that has changed is recalculated, in addition to the effects described in the first embodiment. Using the noise characteristic of the dimension that has not changed and the noise characteristic of the dimension that has changed allows to perform evaluation value calculation corresponding to the change in the noise characteristic.

### Fourth Embodiment

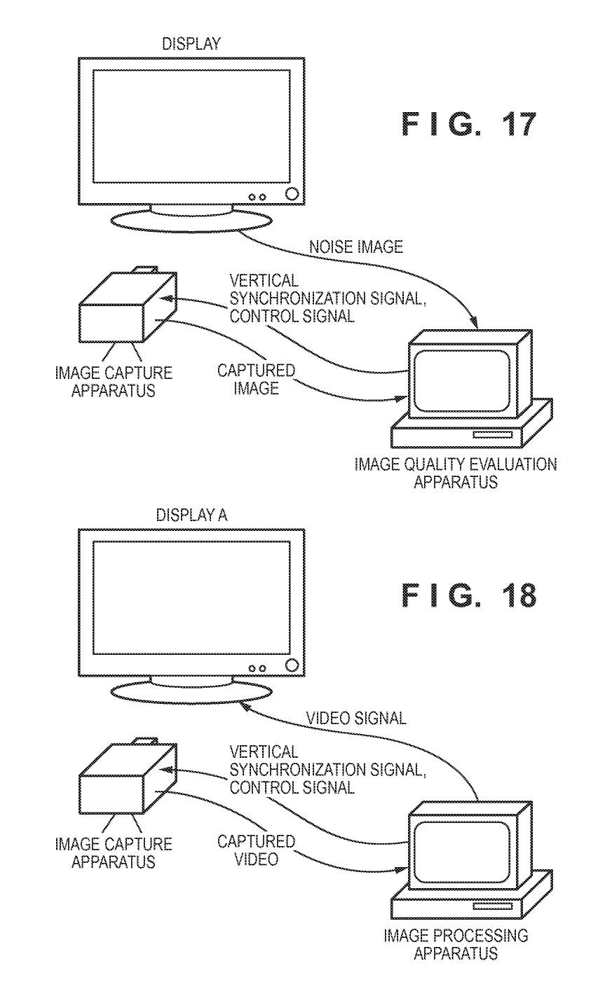

In the above-described embodiments, digital data of an image captured by an image capture apparatus is input, and a quantitative evaluation value of noise is calculated. Actually, however, the noise perception amount largely changes depending on the display on which the image is displayed. A display characteristic such as the response speed of liquid crystal cannot be neglected. When the display is actually captured by a high speed camera (image capture apparatus), and moving image noise evaluation processing is applied to the captured image, as shown in FIG. 17, the display characteristic can be taken into consideration.

A detailed operation of the fourth embodiment will be described below. The image quality evaluation apparatus first outputs an evaluation target noise image to the display. The display receives the evaluation target noise image from the image quality evaluation apparatus and displays the image on the panel. The image capture apparatus receives, from the image quality evaluation apparatus, a control signal and a vertical synchronization signal used to establish synchronization with the display timing of the display, and captures the noise image displayed on the display. The captured noise image is input, and the moving image noise evaluation processing shown in FIG. 5 is applied as subsequent processing, thereby calculating the moving image noise evaluation value.

According to the fourth embodiment, the moving image noise evaluation value can be calculated in consideration of the dynamic characteristic of the display. This allows to evaluate, for example, the difference in noise appearance between displays such as a CRT and an LCD of different characteristics.

It is also possible to calculate the evaluation value by giving a precalculated space-time autocorrelation coefficient of noise as data, instead of giving image data itself as an input. This is because in the present invention, the evaluation value is calculated by multiplying the space-time autocorrelation coefficient of noise, and image data itself is not always necessary.

For example, the autocorrelation coefficients of noise are calculated in advance as a profile based on the characteristics of an image sensor such as a CCD or a CMOS. The autocorrelation coefficients in the profile are given to the processing from step S504 in FIG. 5 to calculate the evaluation value. This allows to calculate the degree of noise to be perceived.

### Fifth Embodiment

In the fifth embodiment, image processing for matching a noise perception amount with a target value in consideration of the characteristics of a display device assuming that the time response characteristic of a video camera is known will be described.

As described above, the appearance of moving image noise generally changes depending on the time response characteristic of a display device such as a display. For example, if the same video is reproduced by a display having a low time response characteristic and a display having a high time response characteristic, noise is hardly perceived in the display having the low time response characteristic. That is, if the same video is displayed by different displays, the perceived noise amount differs. For this reason, to maintain a predetermined noise amount independently of the display used to display the video, it is necessary to match the noise perception amount of the video displayed on the display with the target value.

To match the noise appearance with the target value, the intensity of noise reduction needs to be changed in accordance with the time response characteristic of the display. However, no automatic tuning method considering the time response characteristic of a display has been proposed.

In this embodiment, the time response characteristic of a display is calculated using a camera having a known time response characteristic, and image processing parameters are changed such that the noise evaluation value considering the time response characteristic equals the target value.

FIG. 18 shows an arrangement example according to this embodiment. First, a display is captured using a video camera having a known time response characteristic, thereby acquiring the time response characteristic of the display. In consideration of the acquired time response characteristic of the display and the time response characteristic of the video camera, the noise evaluation value is calculated for each display, and the noise reduction intensity is changed such that the noise evaluation value equals the target value. Note that the arrangement of the image processing apparatus shown in FIG. 18 can be the same as that of the image evaluation apparatus described in the first embodiment.

Detailed moving image noise amount matching processing (or a moving image noise amount matching program) implemented by the image processing apparatus shown in FIG. 18 will be described below. The moving image noise amount matching program specifically operates in the following way.

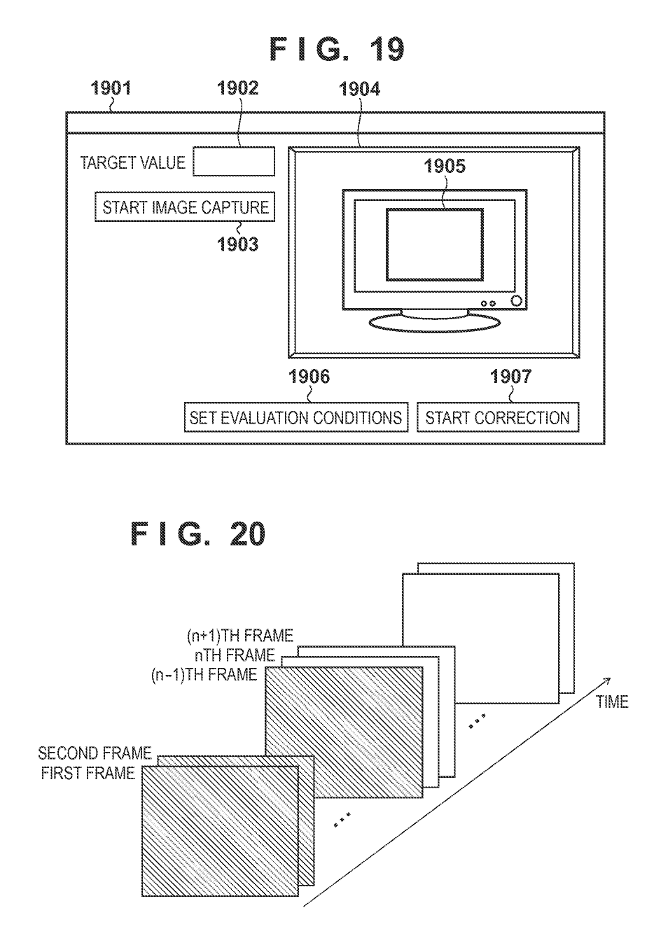

First, the moving image noise amount matching program stored in an HDD 205 is executed by a CPU 201 based on a user instruction input via a keyboard 209 and a mouse 210. An application window 1901 shown in FIG. 19 is thus displayed on a display 212.

To set the target value of the noise amount, the user inputs the target value to a text editor 1902 via the keyboard 209. The target value is a value corresponding to the noise evaluation value described in the first to fourth embodiments.

The user designates an image capture area 1905 on an image display area 1904 via the mouse 210. The image capture area 1905 needs to be set not to be larger than the screen of a display A. When the user selects an image capture start button 1903, a test moving image is output to the display A in accordance with program processing. For example, as shown in FIG. 20, “black” is displayed on the full screen first. From the nth frame, a step response video that displays “white” on the full screen or the like is output. However, the video to be displayed is not limited to this, and a patch image or a line image in the horizontal direction may be displayed. The image processing apparatus controls the image capture apparatus to start capturing the video and acquire captured data Va. The image capture frame rate of the image capture apparatus is assumed to be higher than the frame rate of the display A.

To set evaluation conditions to calculate a quantitative evaluation value, the user presses an evaluation condition setting button 1906. A dialogue window 401 shown in FIG. 4 is displayed on the display 212. In the dialogue window 401, a frame rate setting editor 402 sets the display frame rate of loaded image data. A display vertical pixel pitch setting editor 403 sets the vertical pixel pitch of the display to display the loaded image data. A display horizontal pixel pitch setting editor 404 sets the horizontal pixel pitch of the display to display the loaded image data. Finally, an observer viewing distance setting editor 405 sets a viewing distance for the user to observe the display. When the user presses a setting end button 406, the values input to the setting editors 402, 403, and 404 are stored in, for example, a RAM 203, and display of the dialogue window 401 is disabled.

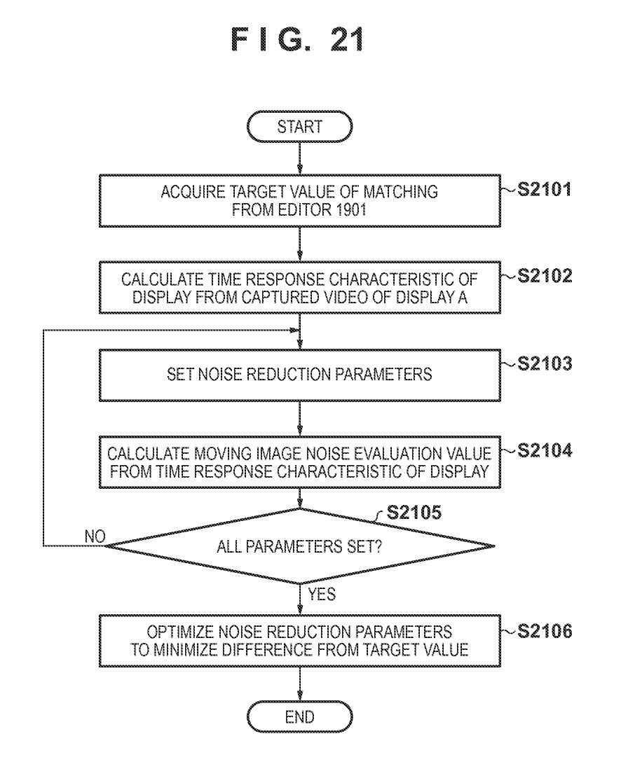

Finally, when the user presses a correction start button 1907, noise amount correction processing according to the flowchart of FIG. 21 to be described later is performed, and noise perception matching processing is executed between the display A and the target value.

The contents of the noise amount correction processing executed by the noise amount matching program will be described below with reference to the flowchart of FIG. 21.

In step S2101, target value acquisition processing is performed. More specifically, the target value of matching is acquired from the editor 1901. The target value will be represented by Dval hereinafter.

In step S2102, display time response characteristic acquisition processing to be described later is executed to obtain a time response characteristic Ra of the display A from the captured video Va of the display A that has been captured and a time response characteristic Rc of the image capture apparatus. Note that if Ra is known, this step may be omitted.

In step S2103, noise reduction parameters are set. The noise reduction can be performed in the image capture apparatus, the display A, or the image processing apparatus.

In step S2104, a noise evaluation value sa for the display is obtained using Ra for the video that has undergone the noise reduction. The detailed operation of the evaluation value calculation processing will be described later.

In step S2105, it is determined whether evaluation value calculation is completed for all noise reduction parameters. If evaluation value calculation is completed for all noise reduction parameters (YES in step S2105), the process advances to step S2106. On the other hand, if evaluation value calculation is not completed for all noise reduction parameters (NO in step S2105), the process returns to step S2103 to newly set the noise reduction parameters.

In step S2106, the noise reduction parameters are optimized by optimum parameter selection processing to be described later such that the noise evaluation value of the display A equals the target value.

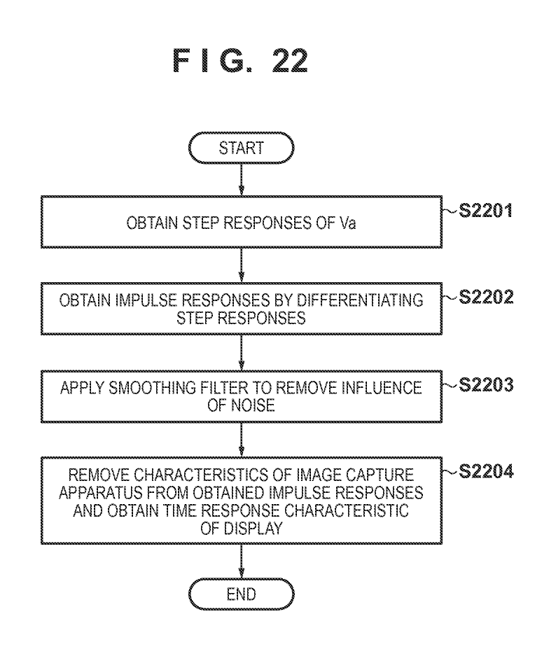

The display time response characteristic acquisition processing will be described below in detail with reference to the flowchart of FIG. 22. A method of obtaining the time response characteristic Ra of the display A will be explained below.

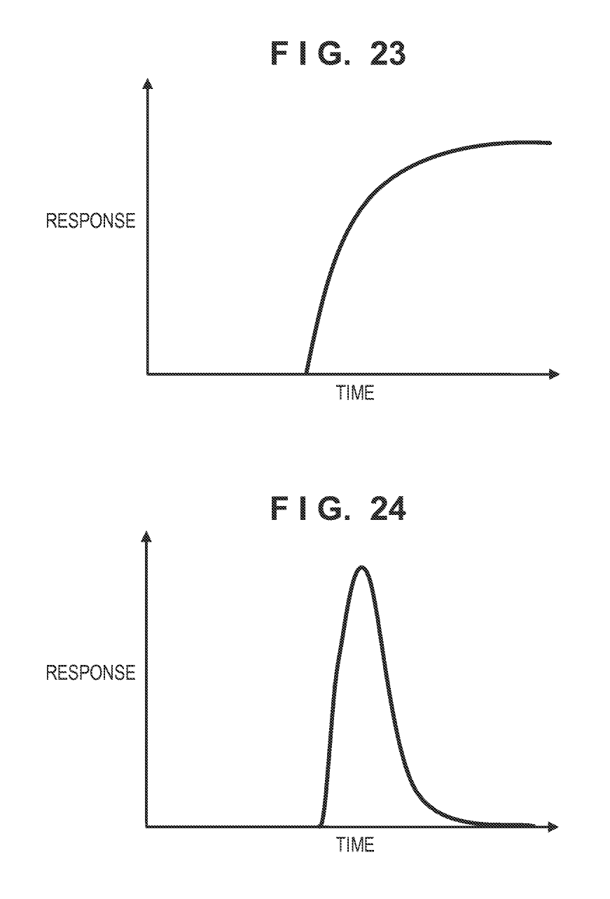

In step S2201, the step videos of the captured video are obtained. Step responses Rsa_L, Rsa_a, and Rsa_b are obtained by calculating the average value of the respective frames of the captured video Va. More specifically, the step responses Rsa_L, Rsa_a, and Rsa_b can be obtained by the following formula (27):

$$Rsa\_L ( t ) = {\sum }_{x , y} Va\_L ( x , y , t ) \\ Rsa\_a ( t ) = {\sum }_{x , y} Va\_a ( x , y , t ) \\ Rsa\_b ( t ) = {\sum }_{x , y} Va\_b ( x , y , t ) \qquad ( formula 27 )$$

where Va_L(x, y, z) is the L* value at the coordinates (x, y) of the tth frame of the captured video Va. Similarly, Va_a(x, y, z) and Va_b(x, y, z) are the a* value and the b* value at the coordinates (x, y) of the tth frame of the captured video Va. Conversion from the captured video Va to Va_L, Va_a, and Va_b is the same as described in the first embodiment. FIG. 23 shows an example of the obtained step response.

In step S2202, impulse responses Ria_L, Ria_a, and Ria_b of the video Va are obtained. The impulse responses Ria_L, Ria_a, and Ria_b can be obtained by differentiating Rsa obtained in step S2201 using the following formula (28):

$$Ria\_L ( t ) = {\sum }_{i = 0}^{1} Rsa\_L ( t - i ) \cdot hd ( i ) \\ Ria\_a ( t ) = {\sum }_{i = 0}^{1} Rsa\_a ( t - i ) \cdot hd ( i ) \\ Ria\_b ( t ) = {\sum }_{i = 0}^{1} Rsa\_b ( t - i ) \cdot hd ( i ) \\ hd = [ - 1 , 1 ] \qquad ( formula 28 )$$

where hd is a differentiation filter. FIG. 24 is a schematic view of the impulse response obtained by performing the processing of this step for the data shown in FIG. 23.

In step S2203, smoothing processing of reducing the influence of noise is performed for Ria_L, Ria_a, and Ria_b to calculate time response characteristic data Ria_L′, Ria_a′, and Ria_b′. The smoothing processing can be performed by a known method. In this case, 5-tap smoothing filter processing is performed for all data of Ria using the following formula (29):

$${Ria\_L}^{′} ( t ) = {\sum }_{i = 0}^{4} Ria\_L ( t - i ) \cdot hb ( i ) \\ {Ria\_a}^{′} ( t ) = {\sum }_{i = 0}^{4} Ria\_a ( t - i ) \cdot hb ( i ) \\ {Ria\_b}^{′} ( t ) = {\sum }_{i = 0}^{4} Ria\_b ( t - i ) \cdot hb ( i ) \\ hb = [ \frac{1}{5} , \frac{1}{5} , \frac{1}{5} , \frac{1}{5} , \frac{1}{5} ] \qquad ( formula 29 )$$

In step S2204, the characteristic of the image capture apparatus is removed from Ria_L′, Ria_a′, and Ria_b′ obtained in step S2203 to obtain time response characteristics Ra_L, Ra_a, and Ra_b of the display only. Ria_L′, Ria_a′, and Ria_b′ include not only the time response characteristics Ra_L, Ra_a, and Ra_b of the display only but also the time response characteristics Rc_L, Rc_a, and Rc_b of the image capture apparatus. To remove the time response characteristics of the image capture apparatus, deconvolution processing is performed for Ria_L′, Ria_a′, and Ria_b′. More specifically, this is implemented by the following formula (30):

Ra_{—}L(t)=ifft(fft(Ria_{—}L′)/fft(Rc_{—}L))

Ra_{—}a(t)=ifft(fft(Ria_{—}a′)/fft(Rc_{—}a))

Ra_{—}b(t)=ifft(fft(Ria_{—}b′)/fft(Rc_{—}b)) (formula 30)

where fft represents Fourier transformation, and ifft represents inverse Fourier transformation.

The operation of the evaluation value calculation processing will be described below concerning points of difference from the first embodiment. In this embodiment, when calculating the correlation of noise in the time direction, the time response characteristic of the display is taken into consideration. More specifically, the time response characteristic of the display is convoluted into the time correlation coefficient of the noise video. To do this, autocorrelation coefficients Ct_L, Ct_a, and Ct_b in the time direction in step S503 are replaced with Ct_L′, Ct_a′, and Ct_b′ given by the following formula (31):

$${Ct\_L}^{′} ( {x}_{f} , {y}_{f} , t ) = {\sum }_{i = 1}^{T} Ct\_L ( {x}_{f} , {y}_{f} , t - i ) * Ra\_L ( i ) \\ {Ct\_a}^{′} ( {x}_{f} , {y}_{f} , t ) = {\sum }_{i = 1}^{T} Ct\_a ( {x}_{f} , {y}_{f} , t - i ) * Ra\_a ( i ) \\ {Ct\_b}^{′} ( {x}_{f} , {y}_{f} , t ) = {\sum }_{i = 1}^{T} Ct\_b ( {x}_{f} , {y}_{f} , t - i ) * Ra\_b ( i ) \qquad ( formula 31 )$$

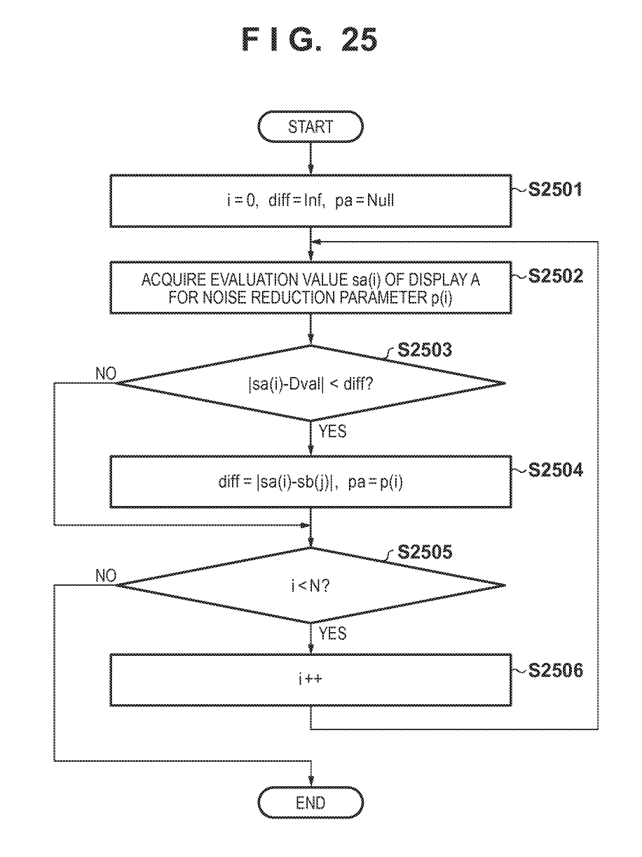

The optimum parameter selection processing will be described below. In the optimum parameter selection processing, a combination of noise reduction parameters that makes the evaluation value of the display A closest to the target value Dval is calculated in a round-robin manner. This will be described in detail with reference to the flowchart of FIG. 25.

In step S2501, initialization is performed. More specifically, i=0, diff=Inf, and pa=Null are substituted, where i is a variable representing the index of a set parameter for the display A, diff is a variable that saves the minimum value of the absolute difference between the target value Dval and the evaluation value of the display A, Inf is a positive infinite value, pa is the optimum parameter for the display A, and Null is an undefined value.

In step S2502, the evaluation value sa(i) of the display A for a noise reduction parameter p(i) is acquired.

In step S2503, it is determined whether the absolute difference between sa(i) and Dval is smaller than diff. If the absolute difference between sa(i) and Dval is smaller than diff (YES in step S2503), the process advances to step S2504. If the absolute difference between sa(i) and Dval is equal to or larger than diff (NO in step S2503), the process advances to step S2505.

In step S2504, the errors of the optimum parameter and the evaluation value are updated. More specifically, diff=|sa(i)−Dval| and pa=p(i) are substituted.

In step S2505, it is determined whether i is smaller than N. N is the total number of set parameters. If i is smaller than N (YES in step S2505), the process advances to step S2506. If i is equal to or larger than N (NO in step S2505), pa obtained by the above-described processing is output as the optimum parameter, and the processing ends. In step S2506, i is incremented.

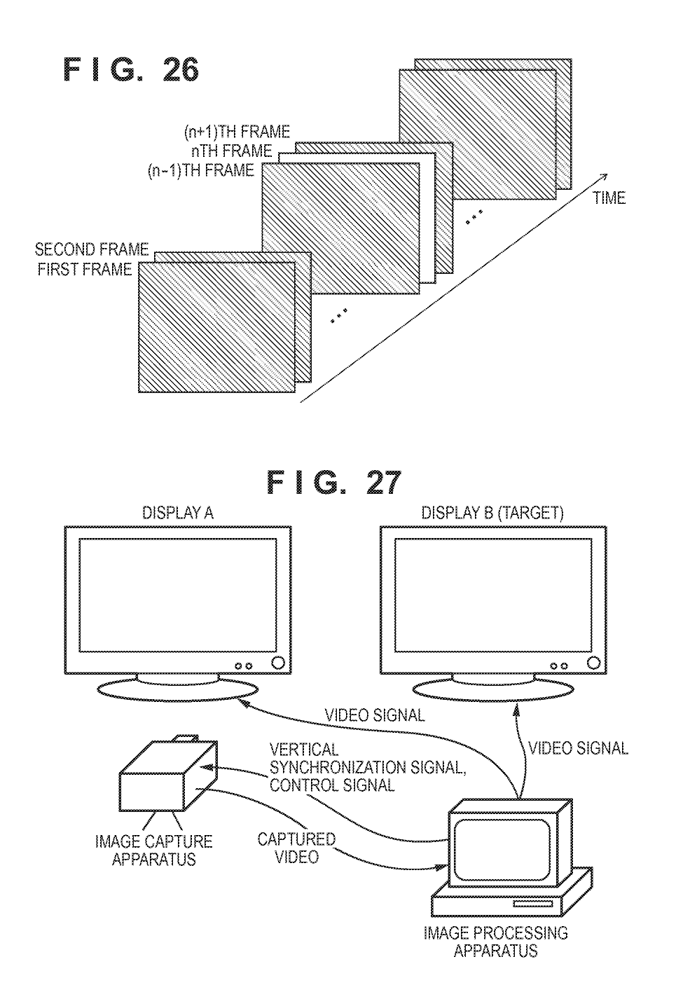

Note that in this embodiment, the step response of the display is captured, thereby obtaining the time response characteristic of the display. However, the present invention is not limited to this. More specifically, an impulse response may directly be acquired by displaying a video shown in FIG. 26 on the display A.

### Sixth Embodiment

In the fifth embodiment, the user directly gives the target value and performs noise matching processing. In the sixth embodiment, matching of the noise perception amount is performed between a plurality of displays. More specifically, first, a plurality of displays are captured, and a noise evaluation value in each display is calculated. Next, one noise evaluation value is set as the target value. Optimum parameters of noise reduction are calculated for the other display, as in the fifth embodiment.

This embodiment will be described below in detail by exemplifying a case in which the noise appearances of two displays are matched with each other, as shown in FIG. 27. Note that the number of displays that undergo the noise appearance matching is not limited to two, and three or more displays may be used. The embodiment will be described below assuming that a display A is matched with a display B.

Detailed moving image noise amount matching processing (or a moving image noise amount matching program) implemented by the image processing apparatus shown in FIG. 27 will be described below. The moving image noise amount matching program specifically operates in the following way.

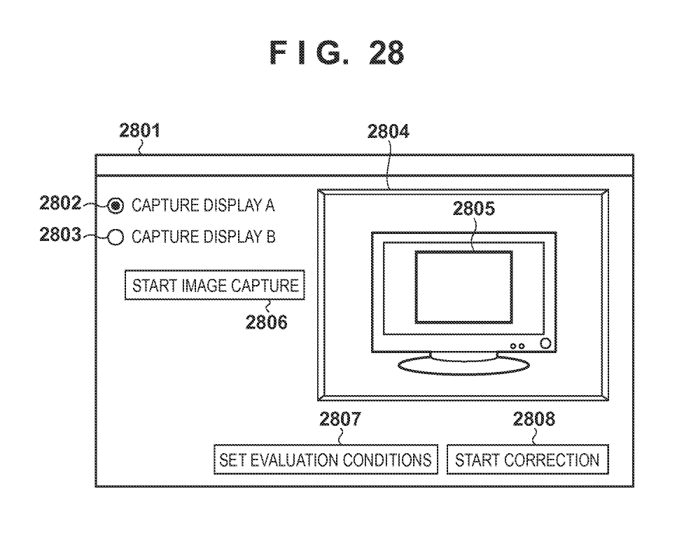

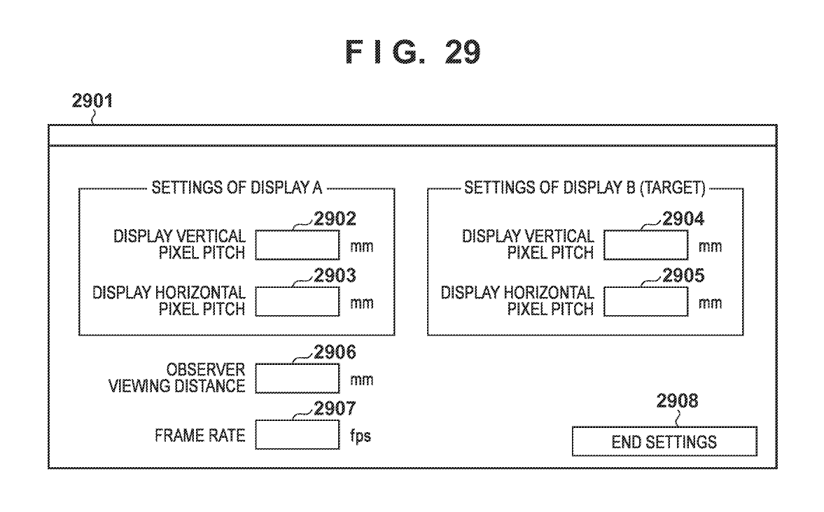

First, the moving image noise amount matching program stored in an HDD 205 is executed by a CPU 201 based on a user instruction input via a keyboard 209 and a mouse 210. An application window 2801 shown in FIG. 28 is thus displayed on a display 212.

To capture the display A, the user presses a selection button 2802. The video that is being recorded by the image capture apparatus is displayed in an image display area 2804. The user designates an image capture area 2805 on the image display area 2804 via the mouse 210. The image capture area 2805 needs to be set not to be larger than the screen of the display A. When the user selects an image capture start button 2806, a video signal is output to the display A in accordance with program processing. The video output here is the same as in the fifth embodiment.

In addition, to capture the display B, the user presses a selection button 2803. The video that is being recorded by the image capture apparatus is displayed in the image display area 2804. Captured data Vb of the display B is acquired in accordance with the same procedure as in capturing the display A.

To set evaluation conditions to calculate a quantitative evaluation value, the user presses an evaluation condition setting button 2807. A dialogue window 2901 shown in FIG. 29 is displayed on the display 212. In the dialogue window 2901, a display A vertical pixel pitch setting editor 2902 sets the vertical pixel pitch of the display A. A display A horizontal pixel pitch setting editor 2903 sets the horizontal pixel pitch of the display A. Similarly, a display B vertical pixel pitch setting editor 2904 sets the vertical pixel pitch of the display B. A display B horizontal pixel pitch setting editor 2905 sets the horizontal pixel pitch of the display B. An observer viewing distance setting editor 2906 sets a viewing distance for the user to observe the displays A and B. A frame rate setting editor 2907 sets the display frame rates of the displays A and B. When the user presses a setting end button 2908, the values input to the setting editors are stored in, for example, a RAM 203, and display of the dialogue window 2901 is disabled.

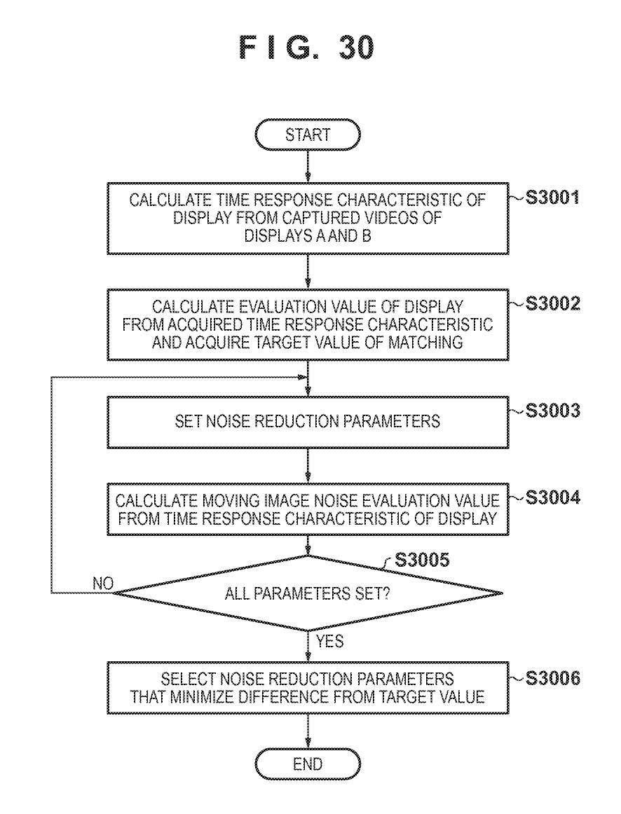

Finally, when the user presses a correction start button 2808, noise amount correction processing according to the flowchart of FIG. 30 to be described later is performed, and noise perception of the display A is matched with that of the display B.

The contents of the noise amount correction processing executed by the noise amount matching program will be described below with reference to the flowchart of FIG. 30.

In step S3001, display time response characteristic acquisition processing is executed to obtain time response characteristics Ra and Rb of the respective displays from the captured videos Va and Vb of the displays A and B that have been captured and a time response characteristic Rc of the image capture apparatus. The method of acquiring Ra and Rb is the same as in step S2102.

In step S3002, the noise evaluation value of the display B that is the matching target is calculated using Rb, thereby acquiring the target value of matching. The evaluation value calculation method is the same as in the fifth embodiment.

In step S3003, noise reduction parameters are set. The noise reduction can be performed in the image capture apparatus, the display A, or the image processing apparatus.

In step S3004, a noise evaluation value sa for the display is obtained using Ra for the video that has undergone the noise reduction.

In step S3005, it is determined whether evaluation value calculation is completed for all noise reduction parameters. If evaluation value calculation is completed for all noise reduction parameters (YES in step S3005), the process advances to step S3006. On the other hand, if evaluation value calculation is not completed for all noise reduction parameters (NO in step S3005), the process returns to step S3003 to newly set the noise reduction parameters.

In step S3006, the noise reduction parameters are selected by optimum parameter selection processing to be described later such that the noise evaluation value of the display A equals the target value.

### Seventh Embodiment

The fifth and sixth embodiments assume that the characteristic of the image capture apparatus is known. However, the characteristic of the image capture apparatus may be changed by the image capture conditions, air temperature, age-related deterioration, or the like, and is not necessarily known. For this reason, to acquire the time response characteristic of a display when performing noise matching, it may be necessary to acquire the time response characteristic of the image capture apparatus.

In this embodiment, the time response characteristic of the image capture apparatus is measured by a display with a known characteristic, and noise perception matching is performed. A case will be explained below in which the time response characteristic of a display B is known, and that of a display A is unknown. However, the present invention is not limited to this. For example, when both the time response characteristic of the display A and that of the display B are unknown, a third display with a known characteristic is prepared to acquire the time response characteristic of the image capture apparatus. The number of displays that undergo the noise appearance matching is not limited to two, and three or more displays may be used. Noise amount matching processing will be described below concerning points of difference from the sixth embodiment.

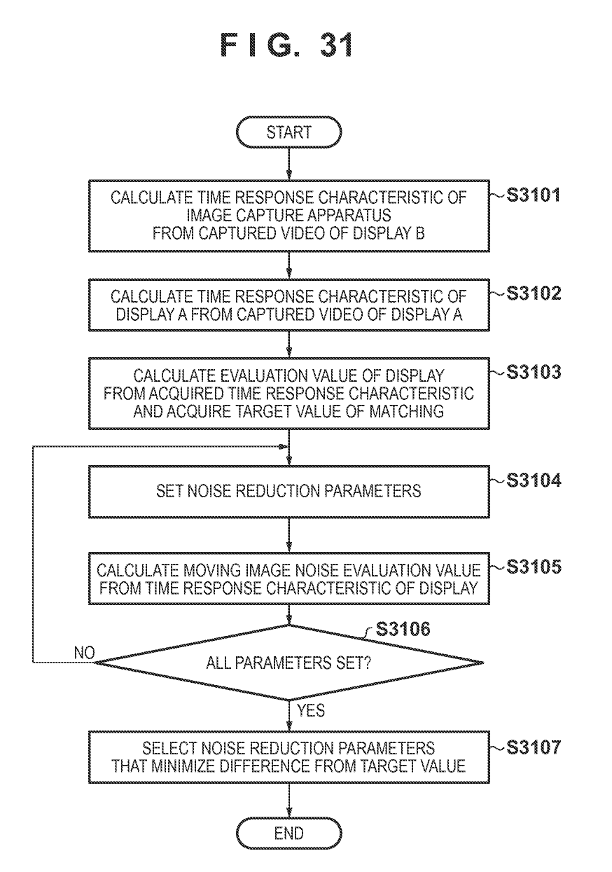

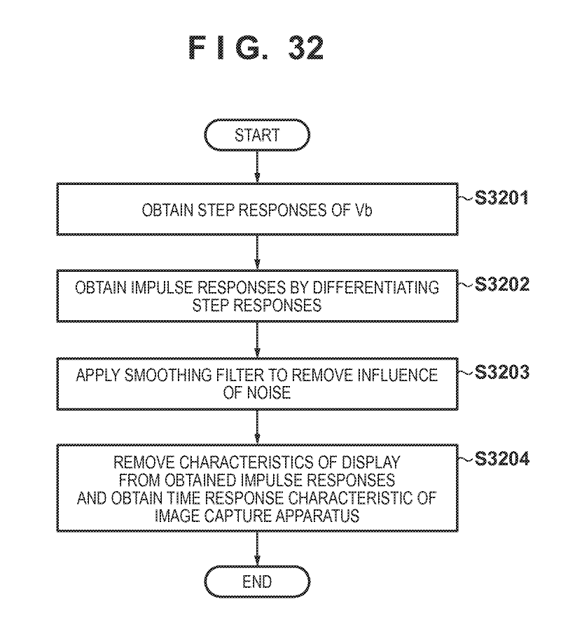

The contents of noise amount correction processing executed by a noise amount matching program will be described below with reference to the flowchart of FIG. 31.

In step S3101, image capture apparatus time response characteristic acquisition processing to be described later is executed to obtain a time response characteristic Rc of the image capture apparatus using the known time response characteristic of the display B.

In step S3102, display time response characteristic acquisition processing is executed to obtain a time response characteristic Ra of the display A from a captured video Va of the display A that has been captured and the time response characteristic Rc of the image capture apparatus. The method of acquiring Ra is the same as in step S2102.

In step S3103, the noise evaluation value of the display B that is the matching target is calculated using Rb, thereby acquiring the target value of matching. The evaluation value calculation method is the same as in the fifth embodiment.

In step S3104, noise reduction parameters are set. The noise reduction can be performed in the image capture apparatus, the display A, or the image processing apparatus.

In step S3105, a noise evaluation value sa for the display is obtained using Ra for the video that has undergone the noise reduction. The detailed operation of the evaluation value calculation processing will be described later.

In step S3106, it is determined whether evaluation value calculation is completed for all noise reduction parameters. If evaluation value calculation is completed for all noise reduction parameters (YES in step S3106), the process advances to step S3107. On the other hand, if evaluation value calculation is not completed for all noise reduction parameters (NO in step S3106), the process returns to step S3104 to newly set the noise reduction parameters.

In step S3107, the noise reduction parameters are selected by optimum parameter selection processing to be described later such that the noise evaluation value of the display A equals the target value.

The image capture apparatus time response characteristic acquisition processing will be described below.

In step S3201, the step videos of the captured video are obtained. Step responses Rsb_L, Rsb_a, and Rsb_b are obtained by calculating the average value of the respective frames of the captured video Vb. More specifically, the step responses Rsb_L, Rsb_a, and Rsb_b can be obtained by the following formula (32):

$$Rsb\_L ( t ) = {\sum }_{x , y} Vb\_L ( x , y , t ) \\ Rsb\_a ( t ) = {\sum }_{x , y} Vb\_a ( x , y , t ) \\ Rsb\_b ( t ) = {\sum }_{x , y} Vb\_b ( x , y , t ) \qquad ( formula 32 )$$

where Vb_L(x, y, z) is the L* value at the coordinates (x, y) of the tth frame of the captured video Vb. Similarly, Vb_a(x, y, z) and Vb_b(x, y, z) are the a* value and the b* value at the coordinates (x, y) of the tth frame of the captured video Vb. Conversion from the captured video Vb to Vb_L, Vb_a, and Vb_b is the same as described in the first embodiment.

In step S3202, impulse responses Rib_L, Rib_a, and Rib_b of the video Vb are obtained. The impulse responses Rib_L, Rib_a, and Rib_b can be obtained by differentiating Rsb obtained in step S3201 using the following formula (33):

$$Rib\_L ( t ) = {{\sum }^{1}}_{i = 0} Rsb\_L ( t - i ) \cdot hd ( i ) \\ Rib\_a ( t ) = {{\sum }^{1}}_{i = 0} Rsb\_a ( t - i ) \cdot hd ( i ) \\ Rib\_b ( t ) = {{\sum }^{1}}_{i = 0} Rsb\_b ( t - i ) \cdot hd ( i ) \\ hd = [ - 1 , 1 ] \qquad ( formula 33 )$$

where hd is a differentiation filter.

In step S3203, smoothing processing of reducing the influence of noise is performed for Rib_L, Rib_a, and Rib_b to calculate time response characteristic data Rib_L′, Rib_a′, and Rib_b′. The smoothing processing can be performed by a known method. In this case, 5-tap smoothing filter processing is performed for all data of Ria using the following formula (34):

$${Rib\_L}^{′} ( t ) = {{\sum }^{4}}_{i = 0} Rib\_L ( t - i ) \cdot hb ( i ) \\ {Rib\_a}^{′} ( t ) = {{\sum }^{4}}_{i = 0} Rib\_a ( t - i ) \cdot hb ( i ) \\ {Rib\_b}^{′} ( t ) = {{\sum }^{4}}_{i = 0} Rib\_b ( t - i ) \cdot hb ( i ) \\ hb = [ \frac{1}{5} , \frac{1}{5} , \frac{1}{5} , \frac{1}{5} , \frac{1}{5} ] \qquad ( formula 34 )$$

In step S3204, the characteristic of the display B is removed from Rib_L′, Rib_a′, and Rib_b′ obtained in step S3203 to obtain time response characteristics Rc_L, Rc_a, and Rc_b of the image capture apparatus only. Rib_L′, Rib_a′, and Rib_b′ include not only the time response characteristics Rc_L, Rc_a, and Rc_b of the camera only but also the time response characteristics Rb_L, Rb_a, and Rb_b of the display B. Hence, the characteristics of the image capture apparatus are removed from Rib_L′, Rib_a′, and Rib_b′ by deconvolution processing. More specifically, this is implemented by the following formula (35):

Rc_{—}L(t)=ifft(fft(Rib_{—}L′)/fft(Rb_{—}L))

Rc_{—}a(t)=ifft(fft(Rib_{—}a′)/fft(Rb_{—}a))

Rc_{—}b(t)=ifft(fft(Rib_{—}b′)/fft(Rb_{—}b)) (formula 35)

where fft represents Fourier transformation, and ifft represents inverse Fourier transformation.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-275089, filed on Dec. 15, 2011 and 2012-265668, filed on Dec. 4, 2012 which are hereby incorporated by reference herein in their entirety.

What is claimed is:

1. An image quality evaluation apparatus for evaluating a noise characteristic of a moving image, comprising:
an acquisition unit configured to acquire autocorrelation coefficients for three dimensions defined by a horizontal direction, a vertical direction, and a time direction of evaluation target moving image data;
a calculation unit configured to calculate a plurality of noise amounts by executing frequency analysis of the autocorrelation coefficients for the three dimensions acquired by said acquisition unit and multiplying each frequency analysis result by a visual response function representing a visual characteristic of one of a spatial frequency and a time frequency; and
an evaluation value calculation unit configured to calculate a product of the plurality of noise amounts calculated by said calculation unit as a moving image noise evaluation value of the evaluation target moving image data.

2. The apparatus according to claim 1, wherein said calculation unit calculates
a first noise amount calculated for the one-dimensional horizontal direction, a second noise amount calculated for the one-dimensional vertical direction, and a third noise amount calculated for the one-dimensional time direction, or
a first noise amount calculated for a two-dimensional space defined by the horizontal direction and the vertical direction, and a second noise amount calculated for the one-dimensional time direction.

3. The apparatus according to claim 1, further comprising:
a conversion unit configured to convert a color space of the evaluation target moving image data; and
an extraction unit configured to extract only a moving image noise component from the moving image data converted by said conversion unit,
wherein said acquisition unit acquires, for the moving image noise component extracted by said extraction unit, the autocorrelation coefficients for the three dimensions defined by the horizontal direction, the vertical direction, and the time direction of evaluation target moving image data;

4. The apparatus according to claim 3, wherein said extraction unit calculates a temporal DC component by averaging the evaluation target moving image data in the time direction, and subtracting the calculated DC component from the moving image data, thereby extracting the moving image noise component.

5. The apparatus according to claim 1, further comprising a designation unit configured to, when at least one of noise characteristics in the horizontal direction, the vertical direction, and the time direction of the evaluation target moving image data has changed after said evaluation value calculation unit has calculated the moving image noise evaluation value for the evaluation target moving image data, designate a direction of the noise characteristic that has changed,
wherein said acquisition unit newly acquires an autocorrelation coefficient for the direction designated by said designation unit,
said calculation unit recalculates the noise amount for the autocorrelation coefficient newly acquired by said acquisition unit, and
said evaluation value calculation unit calculates a product of the noise amount recalculated by said calculation unit and a noise amount for a direction in which the noise characteristic has not changed as a new moving image noise evaluation value of the evaluation target moving image data.

6. The apparatus according to claim 1, further comprising an output unit configured to output the evaluation target moving image data to a display,
wherein each of said acquisition unit, said calculation unit, and said evaluation value calculation unit is executed for a captured image of the evaluation target moving image data output to the display by said output unit, thereby calculating the moving image noise evaluation value in consideration of a dynamic characteristic of the display.

7. A method of controlling an image quality evaluation apparatus for evaluating a noise characteristic of a moving image, comprising:
an acquisition step of, by an acquisition unit, acquiring autocorrelation coefficients for three dimensions defined by a horizontal direction, a vertical direction, and a time direction of evaluation target moving image data;
a calculation step of, by a calculation unit, calculating a plurality of noise amounts by executing frequency analysis of the autocorrelation coefficients for the three dimensions acquired in the acquisition step and multiplying each frequency analysis result by a visual response function representing a visual characteristic of one of a spatial frequency and a time frequency; and
an evaluation value calculation step of, by an evaluation value calculation unit, calculating a product of the plurality of noise amounts calculated in the calculation step as a moving image noise evaluation value of the evaluation target moving image data.

8. A computer-readable storage medium which stores a program that causes a computer to control an image quality evaluation apparatus for evaluating a noise characteristic of a moving image, causing the computer to function as:
an acquisition unit configured to acquire autocorrelation coefficients for three dimensions defined by a horizontal direction, a vertical direction, and a time direction of evaluation target moving image data;
a calculation unit configured to calculate a plurality of noise amounts by executing frequency analysis of the autocorrelation coefficients for the three dimensions acquired by said acquisition unit and multiplying each frequency analysis result by a visual response function representing a visual characteristic of one of a spatial frequency and a time frequency; and
an evaluation value calculation unit configured to calculate a product of the plurality of noise amounts calculated by said calculation unit as a moving image noise evaluation value of the evaluation target moving image data.
